(19) United States
(12) Patent Application Publication
(10) Pub. No.: US 2025/0018571 A1
(43) Pub. Date: Jan. 16, 2025

(54) TECHNIQUES FOR PATH CLEARANCE PLANNING

(71) Applicant: Path Robotics, Inc., Columbus, OH (US)

(72) Inventors: Raghav Sood, Columbus, OH (US); Chaojie Feng, Columbus, OH (US); Surag Balajepalli, Columbus, OH (US); Katsu Yamane, Columbus, OH (US); Matthew Klein, Columbus, OH (US); Sneha Nayak, Columbus, OH (US); Andong Dai, Columbus, OH (US); Nima Ajam Gard, Columbus, OH (US)

(21) Appl. No.: 18/747,421

(22) Filed: Jun. 18, 2024

Related U.S. Application Data
(60) Provisional application No. 63/513,827, filed on Jul. 14, 2023.

(51) Int. Cl. B25J 9/16; B25J 17/00

(52) U.S. Cl. CPC B25J 9/1666; B25J 9/1661; B25J 17/00

(57) ABSTRACT

This disclosure provides systems, methods, and apparatuses, including computer programs encoded on computer storage media, that provide for techniques for manufacturing robots, such as path clearance planning techniques for manufacturing robots. For example, the techniques may generating, based on an end effectuator (EE), a joint, or a combination thereof of a robot arm of the robot for the robot arm in a first state, a plurality of candidate states. The techniques also include, based on the plurality of candidate states, determining a set of verified states. Each verified state may be included in the set of verified states satisfies a clearance threshold value with respect to an object. The techniques further include determining, based on a cost function, a trajectory between the first state and a second state, the second state included in the set of verified states. Other aspects and features are also claimed and described.

### CROSS-REFERENCE TO RELATED APPLICATIONS

The present application claims the benefit of priority of U.S. Provisional Application No. 63/513,827, filed Jul. 15, 2023, which is hereby incorporated by reference in its entirety.

### TECHNICAL FIELD

Aspects of the present disclosure relate generally to the field of manufacturing robots, and more particularly, but not by way of limitation, to path clearance planning techniques for manufacturing robots, such as determining a trajectory for a manufacturing robot that avoids placing the robot in a collision state.

### INTRODUCTION

Conventional robots are generally operable to perform one or more manufacturing operations including, but not limited to, painting, assembling, welding, brazing, or bonding operations to bond or adhere together separated objects, surfaces, seams, empty gaps, or spaces. For example, a robot, such as a manufacturing robot having one or more electrical or mechanical components, may be configured to accomplish a manufacturing task (e.g., welding), to produce a manufacturing output, such as a welded part. To illustrate, the robot (e.g., software, programs, methods, or algorithms) may use a kinematic model of the robot to generate the trajectories that the robot is to follow to accomplish the manufacturing task. For example, conventional robotic welding may use a direct teaching of the robot trajectory that assumes there is no variation in the part geometry or placement, which may be applicable for production with tight manufacturing tolerances. The trajectories are determined for use in driving or moving a component of the robot, such as a weld head, a weld tip, or a sensor, to one or more specific points, positions, or poses.

Robotic manufacturing faces several challenges due to the complexity of the robots used to accomplish manufacturing tasks, variations or tolerances of parts to be welded, sensor noise or sensor calibration, or a combination thereof. For example, variations in part positions, complex geometries of one or more parts, or a combination thereof can create uncertainty. To address this uncertainty, a detailed scan of an entire part may be performed to acquire an accurate location for the part in the environment. However, performing a detailed scan can significantly retard the manufacturing process. Alternatively, a partial scan may be performed which may speed up the process, but can lead to inaccuracies in detecting the overall location and orientation of the part. As another example, sensor noise or sensor calibration may cause or lead to uncertainty in one or more measured values.

To perform an operation on an object, such as a welding operation or a scan operation, the robot arm preferably positions a component, such as an end effectuator (EE) associated with the robot arm, proximate to the object so that the operation may be performed. After performing the operation, the robot arm retracts the EE from a vicinity of the object. However, in some situations, the object may be difficult to reach, with the result that the EE may not be easily positioned at a seam of the object or retracted from the seam of the object. In such situations, attempting to position the EE at the seam or to retract the EE from the seam may cause a collision between one or more components of the robot arm and the object, a first component of the robot arm and a second component of the robot arm, or both. The resulting collision may damage one or more components of the robot, the object, or both.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure is related to apparatuses, systems, and methods that provide a path clearance planning technique for determining a trajectory, such as an approach trajectory or a retract trajectory, for a manufacturing robot that avoids a collision state in a work environment of the robot and that facilitates movement of the robot with respect to an object. A controller associated with the robot may generate a plurality of candidate states of a robot arm that is in a first state, such as an initial state or a goal state. For example, the initial state may be that the robot arm is positioned proximate to the object and is to be retracted from the object. Alternatively, the initial state may be that the robot arm is positioned away from the object and is to be positioned proximate to the object. The controller may generate the plurality of candidate states based on a component of the robot arm, such as based on the EE, a joint of the robot arm, or a combination thereof. For example, the controller may generate the plurality of candidate states by determining one or more line segments from a first point on the robot arm to each of one or more other points on the robot arm. In accordance with the plurality of candidate states, the controller may determine a set of verified states. Each verified state included in the set of verified states satisfies a clearance threshold value with respect to the object. For example, the clearance threshold value may be a value indicating a minimum clearance between the component of the robot arm and the object. Additionally, the controller determines, based on a cost function, a trajectory between the first state and the second state, the second state included in the set of verified states. For example, the cost function may include or correspond to a binary function that determines the validity of a state. Additionally or alternatively, the cost function may include or correspond to a continuous function that determines how well a state satisfies a clearance threshold value with respect to an object. The cost function may include a timeframe in which the trajectory is to be determined, and the trajectory may include or correspond to a complete path from the first state to the second state, a portion of a path from the first state to the second state, or a determination that no feasible path exists between the first state and the second state.

In one aspect of the disclosure, an assembly robotic system for scanning an object to be welded is disclosed. The assembly robotic system includes a controller that includes one or more processors and one or more memories coupled to the one or more processors. The controller is configured to generate, based on an end effectuator (EE), a joint, or a combination thereof of a robot arm of the robot for the robot arm in a first state, a plurality of candidate states. The controller is further configured to, based on the plurality of candidate states, determine a set of verified states. Each verified state included in the set of verified states satisfies a clearance threshold value with respect to an object. The controller is also configured to determine, based on a cost function, a trajectory between the first state and a second state, the second state included in the set of verified states.

In an additional aspect of the disclosure, a method, such as a computer-implemented method, of generating instructions for a robot is disclosed. The method includes generating, based on an end effectuator (EE), a joint, or a combination thereof of a robot arm of the robot for the robot arm in a first state, a plurality of candidate states. The method further includes, based on the plurality of candidate states, determining a set of verified states. Each verified state included in the set of verified states satisfies a clearance threshold value with respect to an object. The method also includes determining, based on a cost function, a trajectory between the first state and a second state, the second state included in the set of verified states.

In an additional aspect of the disclosure, a non-transitory computer-readable medium storing instructions that, when executed by one or more processors of a controller, cause the controller to perform one or more operations. The instructions, when executed, cause the controller to generate, based on an end effectuator (EE), a joint, or a combination thereof of a robot arm of the robot for the robot arm in a first state, a plurality of candidate states. The instructions, when executed, further cause the controller to, based on the plurality of candidate states, determine a set of verified states. Each verified state included in the set of verified states satisfies a clearance threshold value with respect to an object. The instructions, when executed, also cause the controller to determine, based on a cost function, a trajectory between the first state and a second state, the second state included in the set of verified states.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a block diagram illustrating a system configured to enable path clearance planning in a robotic manufacturing environment according to one or more aspects.

FIG. 2 is a flow diagram illustrating an example process of path clearance planning according to one or more aspects.

FIGS. 3A-3D are diagrams that illustrate an example of a technique of path clearance planning according to one or more aspects.

FIGS. 4A-4D are diagrams that illustrate another example of a technique of path clearance planning according to one or more aspects.

FIG. 5 is a diagram to illustrate an autonomous robotic operation that includes path clearance planning according to one or more aspects.

FIG. 6 is a schematic diagram of a technique for generating a plurality of candidate states according to one or more aspects.

FIG. 7 is a diagram of a representation of a robotic arm according to one or more aspects.

FIGS. 8A and 8B are diagrams of data structures that illustrate results of techniques of path clearance planning according to one or more aspects.

FIG. 9 is graph that illustrates an example of a pose-dependent minimum clearance bound according to one or more aspects.

FIG. 10 is a flow diagram illustrating an example process of path clearance planning according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

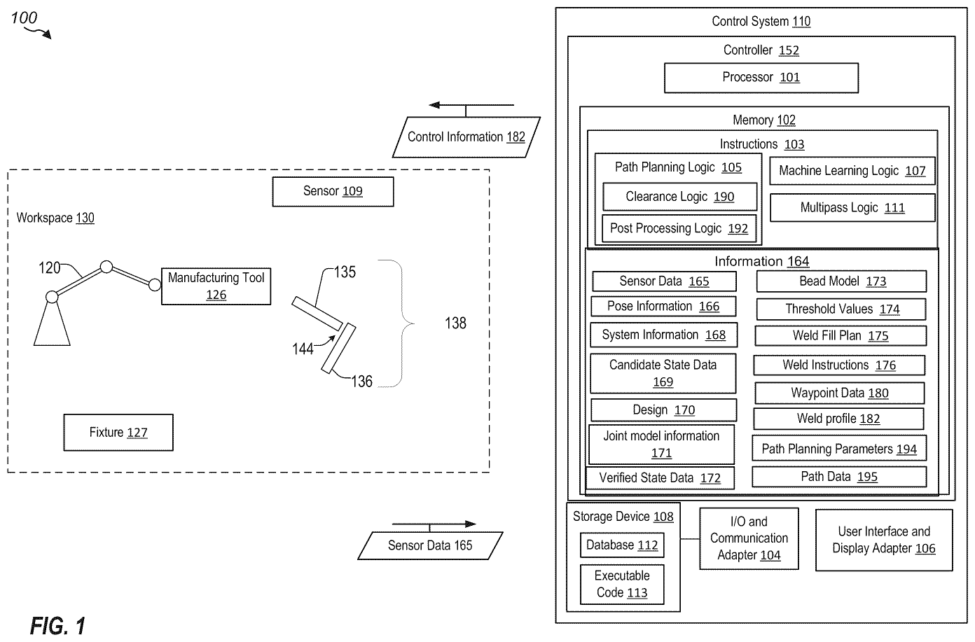

FIG. 1 illustrates a system 100 configured to enable path clearance planning in a robotic manufacturing environment according to one or more aspects. In some implementations, system 100 may include a processor-based system, an assembly robot system, or a combination thereof. System 100 of FIG. 1 is configured to enable path clearance planning for one or more robots (e.g., manufacturing robots) functioning in a semi-autonomous or autonomous manufacturing environment. In some implementations, system 100 supports or is configured to generate instructions for a robot, such as a welding robot or a scanning robot, to perform one or more operations based on a trajectory (or path) determined using a path clearance planning technique.

A manufacturing environment or robot, such as a semi-autonomous or autonomous welding environment or a semi-autonomous or autonomous welding robot, may include one or more sensors to scan a part(s), one or more algorithms in the form of software that is configured to recognize a seam to be welded, and one or more algorithms in the form of software to program motion of a robot, the control of an operator, and any other devices such a motorized fixtures, to weld the identified seams correctly or as desired without collision. Additionally or alternatively, the semi-autonomous or autonomous manufacturing environment or robot may also include one or more sensors to scan a part(s), one or more algorithms in the form of software that recognize, localize, or register a given model of the part(s) where the seams are detected using one or more sensors or have already been denoted in some way perhaps in the given model itself, and one or more algorithms in the form of software to program the motion of the robot(s), the control of the operator, and any other devices such a motorized fixtures, in order to weld the seams correctly or as desired without collision.

System 100 includes a control system 110, a robot 120 (e.g., a manufacturing robot), and a manufacturing workspace 130 (also referred to herein as a “workspace 130”). In some implementations, system 100 may include or correspond to an assembly robot system. System 100 may be configured to couple one or more parts, such as first part 135 (e.g., a first part) and second part 136 (e.g., a second part). For example, first part 135 and second part 136 may be designed to form a seam 144 between first part 135 and second part 136. Each of first part 135 and second part 136 may be any part, component, subcomponent, combination of parts or components, or the like and without limitation. In a conjoined state, first part 135 and second part 136 may comprise object 138.

The terms “position” and “orientation” are spelled out as separate entities in the disclosure above. However, the term “position” when used in context of a part means “a particular way in which a part is placed or arranged.” The term “position” when used in context of a seam means “a particular way in which a seam on the part is positioned or oriented.” As such, the position of the part/seam may inherently account for the orientation of the part/seam. As such, “position” can include “orientation.” For example, position can include the relative physical position or direction (e.g., angle) of a part or candidate seam.

Robot 120 may be configured to perform an operation, such as a welding operation, a scan operation, or both, on one or more parts, such as first part 135 and second part 136. In some implementations, robot 120 can be a robot having multiple degrees of freedom in that it may be a six-axis robot with an arm having an attachment point. Robot 120 may include one or more components, such as an arm, a motor, a servo, hydraulics, or a combination thereof, as illustrative, non-limiting examples.

In some implementations, the attachment point may attach a weld head (e.g., a manufacturing tool 126) to robot 120. Robot 120 may include any suitable tool, such as a manufacturing tool 126, a sensor 109, or a combination thereof. Robot 120 (e.g., a weld head of robot 120) may be configured to move within the workspace 130 according to a path plan or trajectory (e.g., path 195) received from control system 110 or a controller 152. The path plan or trajectory (e.g., path 195) may include or correspond to a trajectory from a first state of robot 120 to a second state of robot 120.

Robot 120 is further configured to perform one or more suitable manufacturing processes (e.g., welding operations) on one or more parts (e.g., 135, 136) in accordance with the received instructions, such as control information 182. In some examples, robot 120 can be a six-axis robot with an arm. In some implementations, robot 120 can be any suitable robotic welding equipment, such as YASKAWA® robotic arms, ABB® IRB robots, KUKA® robots, and/or the like Robot 120, in addition to attached manufacturing tool 126, can be configured to perform arc welding, resistance welding, spot welding, tungsten inert gas (TIG) welding, metal active gas (MAG) welding, metal inert gas (MIG) welding, laser welding, plasma welding, a combination thereof, and/or the like, as illustrative, non-limiting examples. Robot 120 may be responsible for moving, rotating, translating, feeding, and/or positioning the welding head, sensor(s), part(s), and/or a combination thereof. In some implementations, a welding head can be mounted on, coupled to, or otherwise attached to robot 120.

In some implementations, robot 120 may be coupled to or include one or more tools or end effectuators (EEs). For example, based on the functionality the robot performs, the robot arm can be coupled to a tool or EE configured to enable (e.g., perform at least a part of) the functionality. To illustrate, an EE, such as manufacturing tool 126, may be coupled to an end of robot 120. In some implementations, robot 120 may be coupled to or include multiple tools, such as a manufacturing tool (e.g., a welding tool), a sensor, a picker or holder tool, or a combination thereof. In some implementations, robot 120 may be configured to operate with another device, such as another robot device, as described further herein.

In some implementations, the EE is the picker tool or the holder tool that is configured to be selectively coupled to a first set of one or more objects, such as a first set of one or more objects that include first part 135. In some implementations, the picker tool or the holder tool may include or correspond to a gripper, a clamp, a magnet, or a vacuum, as illustrative, non-limiting examples. For example, the EE may include a three-finger gripper, such as one manufactured by OnRobot®.

In some implementations, robot 120, manufacturing tool 126, or a combination thereof, may be configured to change (e.g., adjust or manipulate) a pose of first part 135 while first part 135 is coupled to manufacturing tool 126. For example a configuration of robot 120 may be modified to change the pose of first part 135. Additionally, or alternatively, manufacturing tool 126 may be adjusted (e.g., rotated or tilted) with respect to robot 120 to change the pose of first part 135.

The one or more manufacturing tasks or operations that may be performed via manufacturing tool 126 may include welding, brazing, soldering, riveting, cutting, drilling, or the like, as illustrative, non-limiting examples. In some implementations, manufacturing tool 126 is a welding tool configured to couple two or more objects together. For example, the welding tool may be configured to weld two or more objects together, such as welding first part 135 to the second part 136. To illustrate, the welding tool may be configured to lay a weld metal along scam 144 formed between first part 135 and second part 136. Additionally, or alternatively, the welding tool may be configured to fuse first part 135 and second part 136 together, such as fusing seam 144 formed between first part 135 and second part 136 to couple first part 135 and second part 136 together. In some implementations, manufacturing tool 126 may be configured to perform the one or more manufacturing tasks or operations responsive to a manufacturing instruction, such as a weld instruction.

Workspace 130 may also be referred to as a manufacturing workspace. Workspace 130 may be or define an area or enclosure within which a robot arm(s), such as robot 120, operates on one or more parts based on or in conjunction with information from one or more sensors. In some implementations, workspace 130 can be any suitable welding area designed with appropriate safety measures for welding. For example, workspace 130 can be a welding area located in a workshop, job site, manufacturing plant, fabrication shop, and/or the like. In some implementations, at least a portion of system 100 is positioned with workspace 130. For example, workspace 130 may be an area or space within which one or more robot devices (e.g., a robot arm(s)) is configured to operate on one or more objects (or parts). The one or more objects may be positioned on, coupled to, stored at, or otherwise supported by one or more platforms, containers, bins, racks, holders, or positioners. One or more objects (e.g., 135 or 136) may be held, positioned, and/or manipulated in workspace 130 using fixtures and/or clamps (collectively referred to as “fixtures” or fixture 127). In some examples, workspace 130 may include one or more sensors, fixture 127, and robot 120 that is configured to perform welding-type processes, such as welding, brazing, and bonding on one or more parts to be welded (e.g., a part having a scam).

Fixture 127 may be configured to hold, position, and/or manipulate one or more parts (135, 136). In some implementations, fixture 127 may include or correspond to manufacturing tool 126 (e.g., an EE). Fixture may include a clamp, a platform, a positioner, or other types of fixture, as illustrate, non-limiting examples. In some examples, fixture 127 is adjustable, cither manually by a user or automatically by a motor. For example, fixture 127 may dynamically adjust its position, orientation, or other physical configuration prior to or during a welding process.

Control system 110 is configured to operate and control robot 120 to perform manufacturing functions in workspace 130. For instance, control system 110 can operate and/or control robot 120 (e.g., a welding robot) to perform a scanning or sensing operation, welding operations, or a combination thereof, on one or more parts. Although described herein with reference to a welding environment, the manufacturing environment may include one or more of any of a variety of environments, such as assembling, painting, packaging, and/or the like. In some implementations, workspace 130 may include one or more parts (e.g., 135 or 136) to be welded. The one or more parts may be formed of one or more different parts. For example, the one or more parts may include a first part (e.g., 135) and a second part (e.g., 136), and the first and second parts form a seam (e.g., 144) at their interface. In some implementations, the first and second parts may be held together using tack welds. In other implementations, the first and second parts may not be welded and robot 120 just performs tack welding on the seam of the first and second parts so as to lightly bond the parts together. Additionally, or alternatively, following the formation of the tack welds, robot 120 may weld additional portions of the seam to tightly bond the parts together. In some implementations, robot 120 may perform a multipass welding operation to lay weld material in seam 144 to form a joint.

In some implementations, control system 110 may be implemented externally with respect to robot 120. For example, control system 110 may include a server system, a personal computer system, a notebook computer system, a tablet system, or a smartphone system, to provide control of robot 120, such as a semi-autonomous or autonomous welding robot. Although control system 110 is shown as being separate from robot 120, a portion or an entirety of control system 110 may be implemented internally to robot 120. For example, the portion of control system 110 internal to robot 120 may be as included as a robot control unit, an electronic control unit, or an on-board computer, and may be configured to provide control of robot 120, such as a semi-autonomous or autonomous welding robot.

Control system 110 implemented internally or externally with respect to robot 120 may collectively be referred to herein as “robot controller 110”. Robot controller 110 may be included in or be coupled to a seam identification system, a trajectory planning system, a weld simulation system, another system relevant to the semi-autonomous or autonomous welding robots, or a combination thereof. It is noted that one or more a seam identification system, a trajectory planning system, a weld simulation system, or another system relevant to the semi-autonomous or autonomous welding robots may be implemented independently or externally of control system 110.

Control system 110 may include one or more components. For example, control system 110 may include a controller 152, one or more input/output (I/O) and communication adapters 104 (hereinafter referred to collectively as “I/O and communication adapter 104”), one or more user interface and/or display adapters 106 (hereinafter referred to collectively as “user interface and display adapter 106”), a storage device 108, and one or more sensors 109 (hereinafter referred to ss “sensor 109”). The controller 152 may include a processor 101 and a memory 102. Although processor 101 and memory 102 are both described as being included in controller 152, in other implementations, processor 101, memory 102, or both may be external to controller 152, such that each of processor 101 or memory 102 may be one or more separate components.

Controller 152 may be any suitable machine that is specifically and specially configured (e.g., programmed) to perform one or more operations attributed herein to controller 152, or, more generally, to system 100. In some implementations, controller 152 is not a general-purpose computer and is specially programmed or hardware-configured to perform the one or more operations attributed herein to controller 152, or, more generally, to system 100. Additionally, or alternatively, the controller 152 is or includes an application-specific integrated circuit (ASIC), a central processing unit (CPU), a field programmable gate array (FPGA), or a combination thereof. In some implementations, controller 152 includes one or more memories, such as memory 102, storing executable code, which, when executed by controller 152, causes controller 152 to perform one or more of the actions attributed herein to controller 152, or, more generally, to system 100. Controller 152 is not limited to the specific examples described herein.

In some implementations, controller 152 is configured to control sensor(s) 109 and robot 120 within workspace 130. Additionally, or alternatively, controller 152 is configured to control fixture 127 within workspace 130. For example, controller 152 may control robot 120 to perform operations and to move within workspace 130 according to a path planning techniques. Controller 152 may also manipulate fixture 127, such as a positioner (e.g., platform, clamps, etc.), to rotate, translate, or otherwise move one or more parts within workspace 130. Additionally, or alternatively, controller 152 may control sensor(s) 109 to move within workspace 130 and/or to capture images (e.g., 2D or 3D), audio data, and/or electromagnetic (EM) data.

In some implementations, controller 152 may also be configured to control other aspects of system 100. For example, controller 152 may further interact with user interface (UI) and display adapter 106. To illustrate, controller 152 may provide a graphical interface on UI and display adapter 106 by which a user may interact with system 100 and provide inputs to system 100 and by which controller 152 may interact with the user, such as by providing and/or receiving various types of information to and/or from a user (e.g., identified seams that are candidates for welding, possible paths during path planning, welding parameter options or selections, etc.). UI and display adapter 106 may be any type of interface, including a touchscreen interface, a voice-activated interface, a keypad interface, a combination thereof, etc.

In some implementations, control system 110 may include a bus (not shown). The bus may be configured to couple, electrically or communicatively, one or more components of control system 110. For example, the bus may couple controller 152, processor 101, memory 102, I/O and communication adapter 104, and user interface and display adapter 106. Additionally, or alternatively, the bus may couple one or more components or portions of controller 152, processor 101, memory 102, I/O and communication adapter 104, and user interface and display adapter 106.

One or more processors, such as processor 101, may include a central processing unit (CPU), which may also be referred to herein as a processing unit. Processor 101 may include a general purpose CPU, such as a processor from the CORE family of processors available from Intel Corporation, a processor from the ATHLON family of processors available from Advanced Micro Devices, Inc., a processor from the POWERPC family of processors available from the AIM Alliance, etc. However, the present disclosure is not restricted by the architecture of processor 101 as long as processor 101 supports one or more operations as described herein. For example, processor 101 may include one or more special purpose processors, such as an application specific integrated circuit (ASIC), a graphics processing unit (GPU), a field programmable gate array (FPGA), etc.

Memory 102 may include a storage device, such as random access memory (RAM) (e.g., SRAM, DRAM, SDRAM, etc.), ROM (e.g., PROM, EPROM, EEPROM, etc.), one or more HDDs, flash memory devices, SSDs, other devices configured to store data in a persistent or non-persistent state, or a combination of different memory devices. Memory 102 is configured to store user and system data and programs, such as may include some or all of the aforementioned program code for performing functions of the machine learning logic-based adjustment techniques and data associated therewith.

Memory 102 includes or is configured to store instructions 103 and information 164. In one or more aspects, memory 102 may store the instructions 103, such as executable code, that, when executed by the processor 101, cause processor 101 to perform operations according to one or more aspects of the present disclosure, as described herein. In some implementations, instructions 103 (e.g., the executable code) is a single, self-contained, program. In other implementations, the instructions (e.g., the executable code) is a program having one or more function calls to other executable code which may be stored in storage or elsewhere. The one or more functions attributed to execution of the executable code may be implemented by hardware. For example, multiple processors may be used to perform one or more discrete tasks of the executable code.

Instructions 103 may include path planning logic 105, machine learning logic 107, and multipass logic 111. Path planning logic 105 may include clearance logic 190, post processing logic 192, or a combination thereof. Additionally, or alternatively, instructions 103 may include other logic, such as registration logic. Although shown as separate logical blocks, path planning logic 105, machine learning logic 107, and/or multipass logic 111 may be part of memory 102 and may include the program code (and data associated therewith) for performing functions of path planning machine learning and multipass operations, respectively. For example, path planning logic 105 is configured to generate a path for robot 120 along a seam, including but not limited to, optimizing movements of robot 120 to complete an operation, such a weld, a scan, or both. Additionally or alternatively, although shown as separate logical blocks, path planning logic 105, machine learning logic 107, and multipass logic 111 may be combined. Further, other logic (e.g., registration logic) may be included or combined with, path planning logic 105, machine learning logic 107, and multipass logic 111.

Information 164 may include sensor data 165, system information 168, candidate state data 169, verified state data 172, clearance threshold values 174, path planning parameters 194, and path data 195. Sensor data 165 includes data obtained from sensor 109 and includes or corresponds to sensor data 180. For example, sensor data 165 may include data obtained from one or more scan operations in which a scanner associated with robot 120 scans object 138. The one or more scan operations may include or correspond to a process in which a scan device (including one or more sensors), associated with robot 120, is configured to generate or acquire data corresponding to the one or more portions of the at least one object. Accordingly, sensor data 165 may include images or point cloud data of the one or more portions of the at least one object. For example, the images may include or correspond to visual images (e.g., two dimensional (2D) digital images), electromagnetic images (e.g., radar, LiDAR images), acoustic images, or combinations thereof. System information 168 includes or corresponds to data associated with robot 120. For example system information 168 includes or corresponds to data indicating a topology of robot 120, such as a location of one or more components of a robot arm of robot. To illustrate, locations of joints 302, 304, 402-406 may be stored in memory 102 as system information 168. Additionally, system information 168 may include information associated with one or more devices (e.g., robot 120, manufacturing tool 126, or sensor 109). To illustrate, system information 168 may include ID information, a communication address, one or more parameters, or a combination thereof, as illustrative, non-limiting examples. Additionally, or alternatively, system information 168 may include or indicate a location of seam 144, a path plan, a motion plan, a work angle, a tip position, or other information associated with movement of robot 120, a voltage, a current, a feed rate, or other information associated with a weld operation, or a combination thereof.

Candidate state data 169 includes or corresponds to one or more candidate states generated by controller 152 based on system information 168. Verified state data 172 includes or corresponds to data associated with one or more verified states selected by controller 152 from among candidate state data 169. Threshold values 174 include or correspond to a clearance threshold value, a time threshold value, or both. A clearance threshold value may include or correspond to a threshold value that is associated with a distance between a component of robot 120, such as a component of the robot arm, and an object, such as object 138. A time threshold value may include or correspond to a maximum permitted amount of time for controller 152 to generate path data 195 associated with a trajectory from a first state of the robot arm to a second state of the robot arm. Waypoint data 180 includes or corresponds to data associated with one or more waypoints. Each waypoint may define a position of a weld head or manufacturing tool 126 of the robot 120 such that at each waypoint, the weld head is in a fixed position and orientation relative to a scam, such as scam 144.

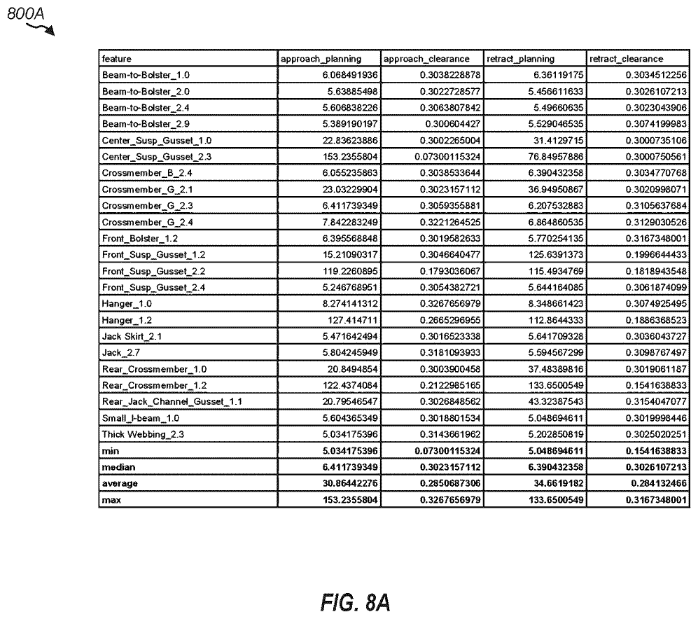

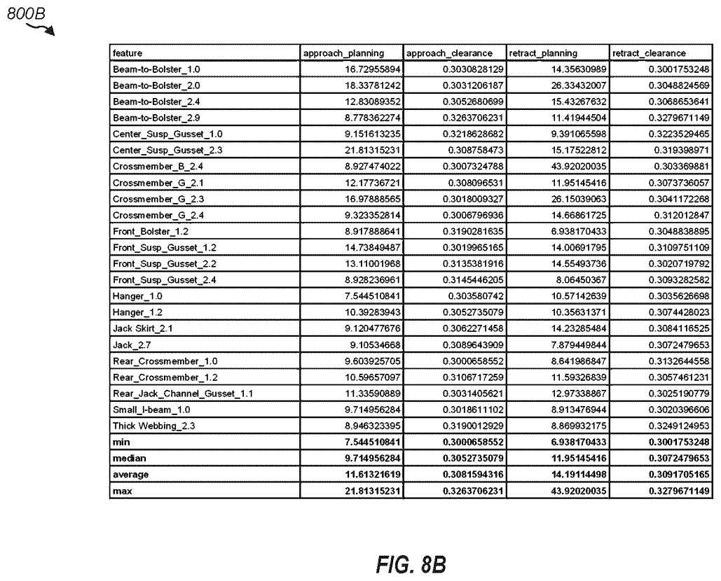

Path planning parameters 194 may include or correspond to values of variables associated with generation of a path or trajectory of robot 120. Examples of path planning parameters 194 are described below with reference to FIGS. 8A and 8B. Path data 195 includes or corresponds to data associated with a trajectory from a first state of a robot arm of robot 120 to a second state of robot arm of robot 120.

Machine learning logic 107 is configured to learn from and adapt to a result based on one or more welding operations performed by robot 120. During or based on operation of system 100, a machine learning logic (e.g., machine learning logic 107) is provided with sensor data 165 associated with at least a portion of a weld formed by robot 120. For example, sensor data 165 may indicate one or more spatial characteristics of a weld. In some implementations, the portion of the weld may include or correspond to one or more passes of a multipass welding operation.

In some implementations, machine learning logic 107 is configured to update a model, such as bead model 173 or a welding model, based on sensor data 165. For example, bead model 173 may be configured to predict a profile of a bead and the welding model may be configured to generate one or more weld instructions (e.g., 176) to achieve the profile of the bead or a weld fill plan (e.g., 175). Controller 152 may generate a first set of weld instructions based on bead model 173, the welding model, or a combination thereof. After execution of the first set of weld instructions by robot 120, controller 152 may receive feedback information (e.g., sensor data 165). Machine learning logic 107 may update bead model 173 or the welding model based on the feedback. Updating bead model 173 or the welding model may involve minimizing an error function that describes the difference between a predicted shape and the shape that is observed after execution. For example, machine learning logic 107 may formulate the error as an L2 norm.

In some implementations, machine learning logic 107 may be configured to identify a set of candidate states corresponding to candidate state data 169. Additionally, or alternatively, machine learning logic 107 may be configured to determine neighboring states.

Multipass logic 111 is configured to determine weld fill plan 175 that includes multiple weld passes for a scam. For example, controller 152 may execute multipass logic 111 to generate one or more welding profiles, a weld fill plan (e.g., 175), one or more weld instructions (e.g., 176), or a combination thereof, as described further herein. Additionally, information 164 may include or indicate pose information 166. Pose information 166 may include or correspond to a pose of first part 135, second part 136, or a combination thereof.

Design 170 may include or indicate a computer aided design (CAD) model of one or more parts. In some implementations, the CAD model may be annotated with or indicate one or more weld parameters, a geometry or shape of a weld, dimensions, tolerances, or a combination thereof. Joint model information 171 may include or indicate a plurality of feature components. The plurality of features components may indicate or be combined to indicate a joint model. In some implementations, each feature component of the plurality of feature components includes a feature point, a feature point vector, a tolerance, or a combination thereof. One or more waypoints constituting waypoint data 180 may include, indicate, or correspond to a location along seam 144.

Bead model 173 is configured to model an interaction of a bead weld placed on a surface. For example, bead model 173 may indicate a resulting bead profile or cross-sectional area of a bead weld placed on the surface. In some implementations, bead model is a first order model that models formation of a bead weld based on an energy source and change of a shape or profile (e.g., an exposed bead cap) of the bead weld.

In some implementations, bead model 173 may be configured to indicate or relate energy sources or sinks associated with a bead that push and pull on an exposed bead cap. Bead model 173 may relate a radius of influence on each energy source or sink has on one or more points of the exposed bead cap. Bead model 173 may also include a weighting face that can be applied to its normal based on equating the influence of each energy source and sink. It is noted that movement along its normal can emulate how area of a bead weld can be redistributed along a surface.

Bead model 173 may also link an end of the expanded bead cap to the surface—e.g., a toe contact angle. To model the toe contact angle, bead model 173 may account for or factor surface tension, torch angle, aspect ratio, or a combination thereof. The surface tension may be associated with pressure on a bead (on a plate) due to gravity. The torch angle may represent a work angle and, therefore, an arc distribution. The closer the torch is to the surface, the greater the temperature of the weld pool which decreases surface tension in a direction of the torch and increases a wetting effect. The aspect ratio may represent an effect that voltage can have on the arc cone angle causing wetting to be more or less pronounced. Bead model 173 may use a first order system model to control the convergence of the bad cap into the wetted toe point.

In some implementations, bead model 173 models energy sources using equations:

$$\begin{matrix}{r}_{p} = p - {o}_{i} \\ {u}_{r} = \frac{{r}_{p}}{‖ {r}_{p} ‖} \\ {α}_{p} = \vert {N}_{p} \cdot {u}_{r} \vert \\ {A}_{p}^{i} = \frac{{A}_{i}}{\vert {A}_{i} \vert \times {A}_{p}} \\ {f}_{o} ( x ) = \frac{1}{σ \sqrt{2 π}} {e}^{( - {x}^{2} / 2 {σ}^{2} )} \\ {E}_{p}^{i} = {f}_{o} ( ‖ {r}_{p} ‖ ) {α}_{p} {A}_{p}^{i} \\ {E}_{p}^{g} = {β}_{g} {N}_{p} \cdot g \\ {w}_{p} = {\sum }_{i} {E}_{p}^{i} ( 1 + {E}_{p}^{g} ) \\ J ( β ) = {A}_{bead} - {A}^{*} ( β w ) \\ {min}_{β ∈ B} J ( β ) = 0\end{matrix}$$

and models the toe contact angle based on equations:

$$\begin{matrix}{r}_{t o e} = {p}_{t o e} - p \\ {r}_{c o m} = {p}_{t o e} - {o}_{c o m} \\ {δ}_{A R} ( {w}_{bead} , {h}_{bead} ) = {w}_{bead} {C}_{AR} ( 1 - {e}^{{AR}_{nominal} - \frac{{w}_{bead}}{{h}_{bead}}} ) \\ {δ}_{W A} ( {d}_{C TWD} , {h}_{bead} , {u}_{torch} , {r}_{toe} ) = {d}_{CTWD} {C}_{W A} ( 1 - {e}^{\frac{- β \text{?}}{{h}_{bead} + \vert \vert {r}_{toe} ‖} {r}_{toe} \cdot {u}_{torch}} ) \\ {δ}_{S T} ( {h}_{bead} , g , {r}_{com} ) = {h}_{bead} {C}_{S T} ‖ g ‖ ( 1 - {e}^{\frac{- β \text{?}}{{h}_{bead} + \vert \vert {r}_{toe} ‖} {r}_{com} \cdot g} ) \\ x = [ {h}_{b ead} , {w}_{b ead} , {d}_{CTWD} , g , {u}_{torch} , {r}_{toe} , {r}_{com} ] \\ {δ}_{wetting} ( x ) = {δ}_{AR} + {δ}_{W A} + {δ}_{ST} \\ ∀ x ∈ [ 0 , 1 ] \\ {β}_{1} ∈ [ 0 , ∞ ) \\ {β}_{2} ∈ ( 0 , ∞ ) \\ {r}_{toe}^{i} = {p}_{toe} - {p}_{i} \\ {α}_{i} ( x ) = {e}^{1 - ( 1 + {β}_{1} ) ( {β}_{2} \frac{s ( x )}{max ( s )} + 1 )} \\ {p}_{i}^{′} ( x ) = {p}_{i} + {α}_{i} ( x ) {r}_{toe}^{i}\end{matrix}$$

$$\text{?} \text{indicates text missing or illegible when filed}$$

where p is a 2D point along a bead segment, Aₚ is the area of a closest internal source at p, Nₚ is the normal of the bead cap at p, oᵢ is the center of mass of the ith energy source, Aᵢ is the area of the ith energy source, σ is a radius of the influence for each energy source, A_{bead} is a parameterized area of the bead model, w_{bead} is a parameterized width of the bead model, h_{bead} is a parameterized height of the bead model, g is a unit vector of gravity in the local reference frame, A* is the functional representing the area distribution algorithm, β is a scalar constant value, C is a scalar constant value, AR is the aspect ratio of a bead (w/h), u_{torch} is the unit vector of the work angle originating from the bead origin, d_{CTWD} is a magnitude of the contact tip to work distance, and s(x) is the arc length of the bead cap segment.

In some implementations, bead model 173 may take the shape of a parameterized curvature model. The parameterization of bead model 173 may help maintain a core shape that can be adjusted to properly model various characteristics under different conditions. Additionally, a bead may be modeled or altered based on one or more interaction models such that a shape profile of the bead can be created with increased accuracy and stability. In some implementations, data may be collected from various testing and experiments to be analyzed and annotated for essential geometric measurements. These measurements may be used in a regression model to associate a bead width and a bead height or aspect ratio, as well as the area with a set of welding parameters.

Cross-sectional weld profile 182 (also referred to herein as “weld profile 182”) may include or indicate a cross-section of seam 144, such as a cross-section of seam 144 that includes weld material. Weld profile 182 may correspond to a waypoint of one or more waypoints associated with waypoint data 180. In some implementations, weld profile 182 may include or indicate a joint model, one or more weld beads or weld bead locations, or a combination thereof. Weld fill plan 175 indicates one or more fill parameters, one or more weld bead parameters (e.g., one or more weld bead profiles), or a combination thereof. The one or more fill parameters may include or indicate a number of beads, a sequence of beads, a number of layers, a fill area, a cover profile shape, a weld size, or a combination thereof, as illustrative, non-limiting examples. The one or more weld bead parameters may include or indicate a bead size (e.g., a height, width, or distribution, a bead spatial property (e.g., a bead origin or a bead orientation), or a combination thereof, as illustrative, non-limiting examples. Additionally, or alternatively, weld fill plan 175 may include or indicate one or more welding parameters for forming one or more weld beads. The one or more welding parameters may include or indicate a wire feed speed, a travel speed, a travel angle, a work angle (e.g., torch angle), a weld mode (e.g., a waveform), a welding technique (e.g., TIG or MIG), a voltage or current, a contact tip to work distance (CTWD) offset, a weave or motion parameter (e.g., a weave type, a weave amplitude characteristic, a weave frequency characteristic, or a phase lag), a wire property (a wire diameter or a wire type—composition/material), a gas mixture, a heat input, or a combination thereof, as illustrative, non-limiting examples.

Weld fill plan 175 may be generated based on one or more weld profiles 182, one or more bead models 173, one or more contextual variables, or a combination thereof. The one or more contextual variables may be associated with or correspond to a joint model. In some implementations, the one or more contextual variables include or indicate gravity, surface tension, gaps, tacks, surface features, joint features, part material properties or dimensions, or a combination thereof. Weld instructions 176 may include or indicate one or more operations to be performed by robot 120. Weld instructions 176 may be generated based on one or more weld profiles 182, weld fill plan 175, or a combination thereof.

In some implementations, controller 152 is configured to optimize weld fill plan 175 including its weld instructions (e.g., 176) based on context specific welding styles in the form of rules formed from application specific requests/needs. Additionally, or alternatively, controller 152 may be configured to determine weld fill plan 175 accounting for or based on additional capabilities including motion capabilities (weaves), additional welding strategies (such as welding tacks), or a combination thereof.

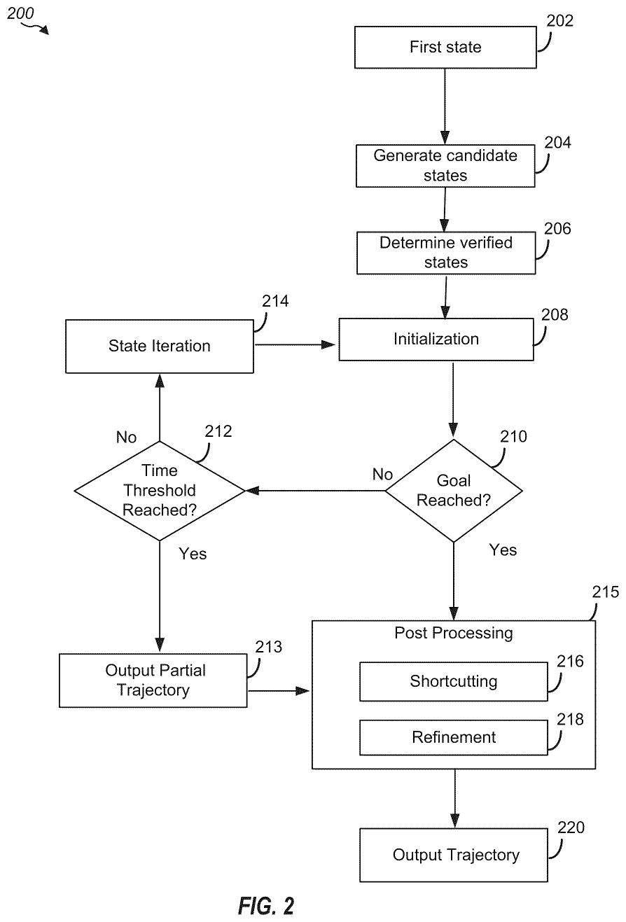

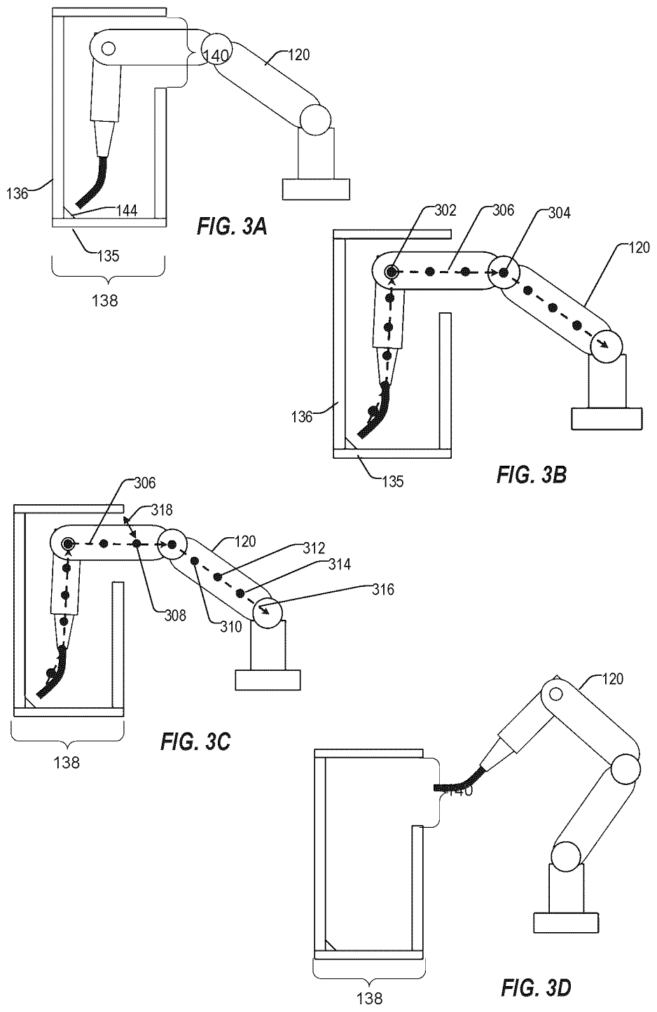

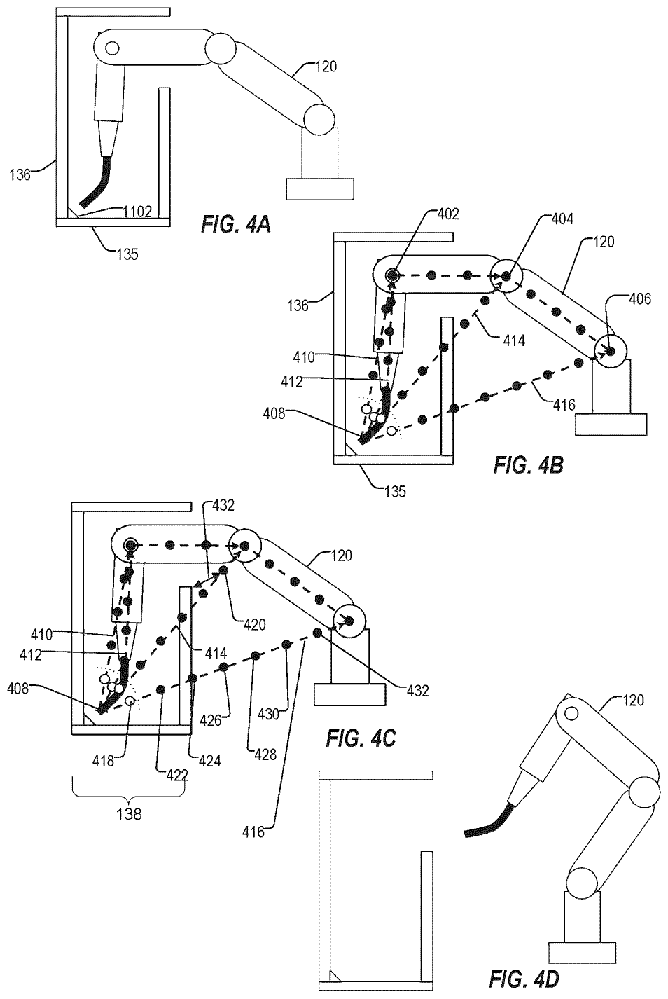

An illustrative example of a cycle of operation of system 100 is described with reference to FIGS. 2-4D. FIG. 2 is a flow diagram illustrating an example process of path clearance planning according to one or more aspects. Operations of process 200 may be performed by a controller, such as controller 152 described with reference to FIG. 1. For example, controller 152, executing path planning logic 105, may be configured to perform process 200. FIGS. 3A-3D are diagrams that illustrate an example of a technique of path clearance planning according to one or more aspects. FIGS. 4A-4D are diagrams that illustrate another example of a technique of path clearance planning according to one or more aspects.

At block 202, robot 120 is in a first state. The first state may include or correspond to an initial state or a goal state. For example and referring to FIGS. 3A and 4A, robot 120 may be in an initial state indicating a first position of robot 120 with respect to object 138 that is comprised of first part 135 cojoined with second part 136 at seam 144. From an initial state corresponding to FIGS. 3A and 4A, controller 152, executing path planning logic 105, may be configured to generate a trajectory whereby robot 120 moves from the initial state of FIGS. 3A and 4A to a goal state of FIGS. 3D and 4D while passing through clearance distance 140 without colliding with any part of object 138, with any component or robot 120, with any component of workspace 130, or a combination thereof. In the goal state depicted in FIGS. 3D and 4D, robot 120 is in a second position with respect to object 138.

Alternatively, FIGS. 3D and 4D may include or correspond to the initial state and FIG. 3A and FIG. 4A may include or correspond to the goal state. Accordingly, controller 152, executing path planning logic 105, may be configured to generate a trajectory whereby robot 120 moves from the initial state depicted in FIGS. 3D, 4D to the goal state depicted in FIGS. 3A, 4A passing through clearance distance 140 without colliding with any part of object 138, with any component or robot 120, with any component of workspace 130, or a combination thereof.

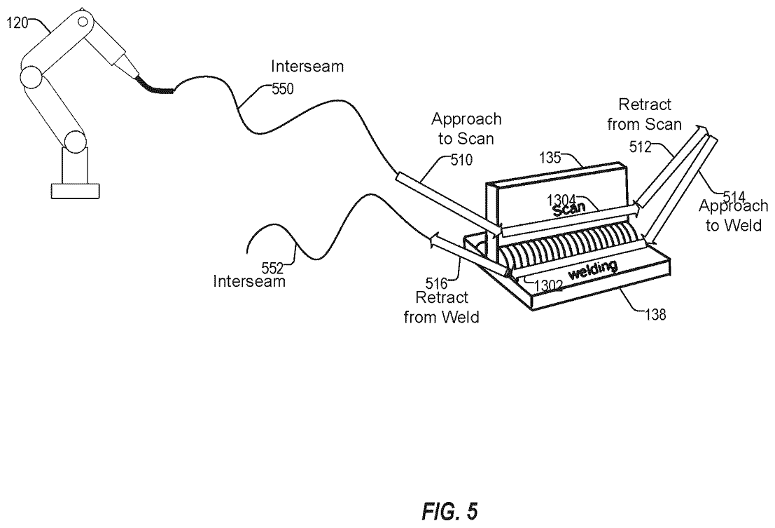

Accordingly, in some implementations, the initial state is associated with an approach of the robot arm of a robot, such as robot 120, to perform an operation, and the goal state is associated with a retraction of the robot arm after performance of an operation. The operation may include or correspond to a welding operation, a scan operation, or a combination thereof. Referring to FIG. 5, FIG. 5 is a diagram to illustrate an autonomous robotic operation that includes path clearance planning according to one or more aspects. As depicted in FIG. 5, the initial state may include or correspond to approach to scan 510 at interseam 550 of object 138, and the goal state may include or correspond to retract from scan 512. Additionally or alternatively, the initial state may include or correspond to approach to weld 514 at interseam 552, and the goal state may include or correspond to retract from weld 516.

At block 204, the controller may generate, based on a component of robot arm of robot 120 that is in the first state (e.g., depicted in FIG. 3A, 4A or 3D, 4D), a plurality of candidate states. The component of robot arm may include or correspond to one or more joints 302, 304, 402-406 of the robot arm of robot 120 as illustrated in FIG. 3B, 4B. Additionally, the component of robot arm may include EE 408 as depicted in FIG. 4B. To generate the plurality of candidate states, the controller, such as controller 152, executing clearance logic 190 of path planning logic 105, may determine one or more line segments associated with the robot arm. For example and referring to FIG. 3B, controller 152 may determine line segment 306 between joint 302 and joint 304. As another example, controller 152 may determine line segments 410-416 between EE 408 and each of joints 402-406. Additionally, to generate the plurality of candidate states, controller 152 may determine for each line segment of the one or more line segments, a candidate state on the line segment and included in the plurality of candidate states. For instance, controller 152 determines candidate state 308 associated with line segment 306. As another example, controller 152 may determine candidate state 420 associated with line segment 414 and candidate state 418 associated with line segment 416. In some implementations, to generate the plurality of candidate states, controller 152 may determine, for each line segment of one or more line segments, a number of candidate states associated with the line segment and that are evenly spaced along the line segment. For example and referring to FIG. 3C, controller 152 may determine candidate states 310-314 along line segment 316. As another example and referring to FIG. 4C, controller 152 may determine candidate states 418-432 along line segment 416.

At block 206, the controller may determine, based on the plurality of candidate states, a set of verified states. Each verified state included in the set of verified states satisfies a clearance threshold value with respect to an object. To illustrate and referring to FIG. 3C, controller 152, executing clearance logic 190 of path planning logic 105, may determine that candidate state 308 may satisfy clearance threshold value 318 with respect to object 138. Clearance threshold value 318 may include or correspond to a threshold value, such as stored in memory 102, that is associated with a distance between a component of robot 120, such as a component of the robot arm, and an object, such as object 138. Accordingly, controller 152 may include candidate state 308 in the set of verified states. As another example, controller 152 may determine that candidate state 420 satisfies clearance threshold value 432 with respect to object 138. Thus, controller 152 may include candidate state 420 in the set of verified states.

At block 208, controller may initialize one or more path planning parameters. For example, controller 152 may initialize one or more path planning parameters 194. Path planning parameters 194 may include or indicate a kinematics model such as may be associated with robot 120, a planning space, a collision checking interface, a heuristic, a cost, an optimization objective, a discretization, one or more motion primitives, a start state, a goal clearance, one or more ignore distances, one or more clearance objections, a planning time threshold (e.g., a maximum planning time threshold), or a combination thereof. FIGS. 8A and 8B include additional examples of path planning parameters 194. For instance, the variables “approach_planning,” “approach_clearance,” “retract_planning,” and “retract_clearance,” as shown and explained with reference to FIGS. 8A and 8B, may include or correspond to path planning parameters 194.

At block 210, the controller, such as controller 152, may determine whether a goal state is reached based on a simulation of one or more trajectories of the robot arm of robot 120. Controller 152 may generate the one or more trajectories based on one or more of the verified states and using one or more of the path planning parameters, such as path planning parameters 194. To illustrate, controller 152 may determine, based on a cost function, a trajectory between the first state and a second state, the second state included in the set of verified states. For example, the cost function may include or correspond to a binary function that determines the validity of a state. Additionally, or alternatively, the cost function may include or correspond to a continuous function that determines how well a state satisfies a clearance threshold value with respect to an object.

In some implementations, clearance logic 190 is configured to plan or determine a trajectory (e.g., path 195) of robot 120. For example, clearance logic 190 may be configured to determine the trajectory that has or achieves a minimum clearance threshold, that reduces an overall cost to get from a start state (e.g., an initial state) to a goal state, or a combination thereof. In some implementations, the trajectory may be associated with or include a weld path, an approach to the weld path, or a retract from the weld path, as illustrative, non-limiting examples. Additionally, or alternatively, the trajectory may be associated with or include a scan path, an approach to the scan path, or a retract from the scan path, as illustrative, non-limiting examples. For example, clearance logic 190 may be used as a safer free space algorithm to move away from a critical state or a close-to-collision state. To illustrate, clearance logic 190 may be used as part of or prior to a pre-scan (e.g., to approach or retract from a pre-scan path) which involves scanning the seam and finding the correct location of it, and computing the corrections between where the seam was expected to be and where it actually is. The pre-scan operation may involve coming close to seam 144, but not as close as is needed with a weld trajectory. In some implementations, controller 152 may use clearance logic 190 based on a need or a potential of planning a path that starts or ends close to part 135 or 136.

In some implementations, clearance logic 190 may utilize or initialize one or more path planning parameters 194. The one or more path planning parameters 194 may include or indicate a robot/kinematics model, a planning space, a collision checking interface, a heuristic, a cost, an optimization objective, a discretization, one or more motion primitives, a start state, a goal clearance, one or more ignore distances, one or more clearance objections, a planning time threshold (e.g., a maximum planning time threshold), or a combination thereof.

The robot/kinematics model may indicate or define one or more specifications of robot 120, such as a structure, one or more joints, one or more sensors, other components of robot 120, or a combination thereof. A format (e.g., usually configured in URDF in ROS) of the robot model may enable a user or controller 110 to specify the visual, geometric, kinematic, and dynamic properties of a robot. The planning space may refer to or define a representation of a domain where the algorithm, such as the clearance logic 190, is configured to operate on. For example, the planning space may define the state space and connectivity between states, allowing the algorithm to explore and find a path from the start state to the goal state. The collision checking interface indicates or defines a collision detection mechanism to ensure that a generated path (e.g., 195) is collision-free. The collision detection mechanism may be configured to check for potential collisions between the robot 120 (e.g., the robot arm) and the environment or any obstacles/objects present in the environment.

The heuristics of the one or more parameters may include or indicates a difference between desired goal clearance and a distance to a collision of the arm in a current configuration/state. The cost of each state may be defined by the difference between the clearance achieved by the previous state and the clearance with its neighbor. The optimization objective may include or indicate the objective that needs to be optimized. For example, the object may be the difference between the distance to the collision of the current robot configuration/state and the neighboring configuration/state. The discretization may indicate or define the discretization or resolution of a planning space and/or an action space. For example, discretization may include or indicate a number of joints present in the robot arm.

The motion primitives may include or indicate a set of increments or decrements in joint angles of each joint of the robot arm that can be taken in transitioning from one state to another in the planning space. Each increment or decrement can be considered an action. The start state may include or indicate one or more starting joint positions of the robot, which defines the start state of the trajectory which clearance logic 190 needs to compute.

The goal clearance may include or indicate a desired clearance to be achieved. The ignore distances may include or indicate one or more objects to ignore for a clearance computation. The clearance objects may include or indicate one or more objects to be considered for clearance checking. The planning time threshold (e.g., a maximum planning time threshold) may include or indicate an allowed planning time (e.g., a maximum allowed planning time) within which a solution is to be found. If the solution is not found within the planning time threshold, no solution is returned or a partial solution may be returned (e.g., output).

In some implementations, to generate the one or more trajectories, controller 152, executing clearance logic 190, may implement an A* algorithm to identify a path (e.g., path data 195). The A* algorithm may be considered a complete algorithm, meaning it finds an optimal path if one exists. However, the A* algorithm does not have an “anytime” behavior, which means the A* algorithm needs to complete its entire search before returning a solution (e.g., path 195). In scenarios where there are constraints on time or resources, the A* algorithm may not be suitable as it cannot provide a solution until it finishes the entire search, which may be problematic in situations where identifying the solution quickly, in a short time period is desired.

The A* algorithm that is configured to search with inflated heuristics is suboptimal but proves to be fast for many domains. To construct an anytime algorithm using the A* algorithm, the A* algorithm may be configured with sub-optimality bounds such that a succession of these A* searches are run with decreasing inflation factors. This naive approach results in a series of solutions, each one with a sub-optimality factor equal to the corresponding inflation factor. The approach, however, may waste a lot of computation since each search iteration duplicates most of the efforts of the previous searches.

In some implementations, clearance logic 190 is configured to employ the use of an Anytime Repairing A* (ARA*) algorithm. The ARA* algorithm may be an efficient anytime heuristic search that also runs A* with inflated heuristics in succession but reuses search efforts from previous executions in such a way that the suboptimality bounds are still satisfied. As a result, a substantial speedup is achieved by not re-computing the state values that have been correctly computed in the previous iterations.

To use the ARA* algorithm in a welding-specific application—e.g., to plan an approach trajectory or a retract trajectory, clearance logic 190 may define an environment or a planning space that is understandable to the ARA* algorithm. For example, clearance logic 190 may define or initialize one or more path planning parameters 194. To illustrate, clearance logic 190 may define or initialize an action space, which refers to the set of possible actions or movements that can be taken from each state during the search process.

In the context of motion planning for a robot arm (e.g., of robot 120), the action space may include a set of valid movements or joint configurations that the robot arm can perform. In some implementations, the robot arm may include multiple degrees of freedom (DOF), such as a 6 DOF robot arm, with the action space of each joint of the robot arm adjusted individually, allowing for specific angle changes. Additionally, or alternatively, the action space may include different increments or decrements for each joint. These sets of increments in each joint can be defined by motion primitives.

In some implementations, the ARA* algorithm may use a heuristic to guide the search to a goal state. Additionally, each state in the planning space has a cost associated with the state. The cost at each state may be the difference between a clearance achieved by the previous state and a neighbor of the state.

In some implementations, clearance logic 190 that uses the ARA* algorithm may identify a start state and to operate until a state is identified that satisfies the clearance threshold and provides an optimal path (e.g., 195). The ARA* algorithm may be configured to incrementally build a graph using motion primitives in joint space until the desired clearance is achieved or given planning time has elapsed. Inputs of the ARA* algorithm may be provided or initialized based on or using the one or more path planning parameters. For example, in some implementations, clearance logic 190 may initialize one or more path planning parameters 194 for use by or with the ARA* algorithm. The ARA* algorithm may sample motion primitives (in joint space) until desired clearance is achieved or until a time threshold has elapsed. The ARA* algorithm may also be configured to use distance as heuristics. In some implementations, once the goal state is encountered in the graph, clearance logic 190 (e.g., the ARA* algorithm) may use backtracking to get the optimal path to the goal state.

The ARA* algorithm may have issues or difficulties with identifying possible solutions in situations where one or more parts have complex geometries. For example, the ARA* algorithm may take a long time to achieve desired clearance. As another example, a resulting path (e.g., 195) may be redundant (and have a long execution time), such that additional post-processing is need for the path. Further the resulting path may appear “weird” (e.g., jittery or non-smooth) based on the motion primitives that produce the resulting path.

Alternatively, in some implementations, clearance logic 190 may perform a two-step process in which a first step is configured to find one or more candidate states that achieve the desired clearance. The one or more candidate states may be or include a set of candidate states (e.g., one or more candidate goal states) that include or correspond to candidate state data 169. The set of candidate states may include a set of predefined samples, a set of random sample states, or a combination thereof. A candidate state may include a vector of angles for each joint of the robot (e.g., the robot arm). The clearance may include or indicate a distances, such as minimum distance, between the part (e.g., 135 or 136) and all robot links of the robot arm. In some implementations, the set of candidate states may include one or more states along one or more line segments (consecutive line segments) that connect the joint frames from an end-effector (EE) to a root (or base joint) of the robot arm. An example of the set of candidate states is described further herein at least with reference to FIGS. 3A-3D. Additionally, or alternatively, the set of candidate robot states may include one or more states along one or more line segments that connect an EE to each joint of the robot arm. An example of the set of candidate robot states is described further herein at least with reference to FIGS. 4A-4D.

An orientation at each state (or each link) may include predefined samples, such as rotation around or about a local x, y, or z axis. Clearance logic 190 may be configured to compute inverse kinematics (IK) and clearance for every position and orientation pair until pose(s) with sufficient clearance are found. In some implementations, clearance logic 190 may process each candidate robot state in an effort to identify a set of goal states. Additionally, or alternatively, clearance logic 190 may process the candidate robot states until a number (e.g., 1, 2, 3, etc.) of goal states is identified. In some implementations, clearance logic 190 may use machine learning logic 107 to determine or select a goal state based on the set of candidate robot states. In some implementations, clearance logic 190 is configured to select a goal state (e.g., a single goal state or a number of goal states) from multiple goal states for additional processing at a second step of the two-step process.

In some implementations, to improve or increase computation time, clearance logic 190 may be configured to implement parallelization for faster computation. For example, clearance logic 190 may distribute position samples to multiple threads. In some such implementations, clearance logic 190 or the one or more parameters 194 includes an open motion planning library (OMPL) or the like that supports multiple start/goal states. Each thread may be configured to check all orientation samples. In such implementations, clearance logic 190 may be more likely to find states with end-effector orientations similar to the start orientation. A main thread may check the maximum clearance every X seconds (e.g., X=0.5 seconds). In some implementations, once a first clearance state is identified, clearance logic 190 may wait for a time period, such as another X seconds or a different time period, to see if another clearance state is identified before stopping the threads.

The two-step process performed by clearance logic 190 may include a second step that is configured to find a path between a start state and the goal state. It is noted that the areas occupied by the robot arm at the start and end of the weld trajectory are collision-free. In some implementations, the second step may be considered a standard point-to-point path planning problem and the second step performed by clearance logic 190 may use a variety of path planning algorithms to perform the second step.

In some implementations, to perform the second step, clearance logic 190 may use or implement one or more techniques. For example, the one or more techniques may include the A* algorithm, a Rapidly-exploring Random Tree (RRT) technique, a Probabilistic RoadMap (PRM) technique, or a combination thereof. In some implementations, clearance logic 190 may use an RRTConnect technique, which is a variation of RRT where two trees are expanded from both start and goal states. Additionally, or alternatively, clearance logic 190 may use an open motion planning library (OMPL) or the like that is accessible via a native API of control system 110. The OMPL may provide flexibility with respect to validation/cost functions.

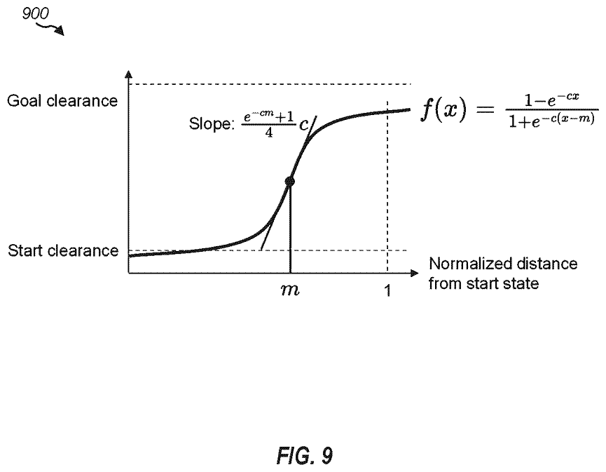

In some implementations, a state may be determined to be valid during the second step if a distance from the state to a part is greater than or equal to an initial distance (of a start state or a previous state) or if a clearance to part is greater than a function of joint-space distance to initial state. In some such implementations, such as when the state is determined to be valid if a clearance to part is greater than a function of joint-space distance to initial state a pose-dependent minimum clearance bound may be used, as described further herein at least with reference to FIG. 9.

In some implementations, a time threshold may be allocated such that controller 152 may simulate one or more trajectories (e.g., using an A* algorithm, an ARA* Algorithm, a two-step algorithm, a cost function, or some combination thereof, as nonlimiting examples). Accordingly, at block 212, controller 152 determines whether the time threshold is reached. If the time threshold is not reached, at block 214, state iteration occurs in which controller 152 simulates additional trajectories based on additional verified states within the set of verified states.

However, if the time threshold is reached, at block 213, controller 152 outputs a partial trajectory from the first state to the second state. At block 215, controller 152 performs post processing of the partial trajectory. Post processing may include shortcutting 216, refinement 218, or both. To illustrate, controller 152, at block 216, implements a trajectory shortcutting algorithm to remove unnecessary states. In some implementations, the trajectory shortcutting algorithm is implemented because the ARA* algorithm used to generate the produced solution may provide a partial solution if it cannot find a near-perfect solution within the time limits. For example, the produced solution may be a sub-optimal solution with additional, unnecessary movements and joint displacements, which can increase execution time and reduce overall efficiency and cycle time.

At block 218, controller 152 may perform refinement of the solution via a refining step. For example, ARA* may incorporate iterative deepening and anytime behavior, which allows for refinement of the produced solution and the ability to terminate the ARA* algorithm at any point and return the best path found thus far. As such, the refinement performed at block 218 can increase the overall clearance of the solution path as compared to the originally planned trajectory.

At block 220, controller 152 outputs the trajectory. In some implementations, to determine the trajectory, controller 152 may identify a portion of a path from the first state to the second state. Alternatively, controller 152 may determine that no feasible path exists between the first state and the second state. Further, controller 152 may identify a complete path from the first state to the second state.

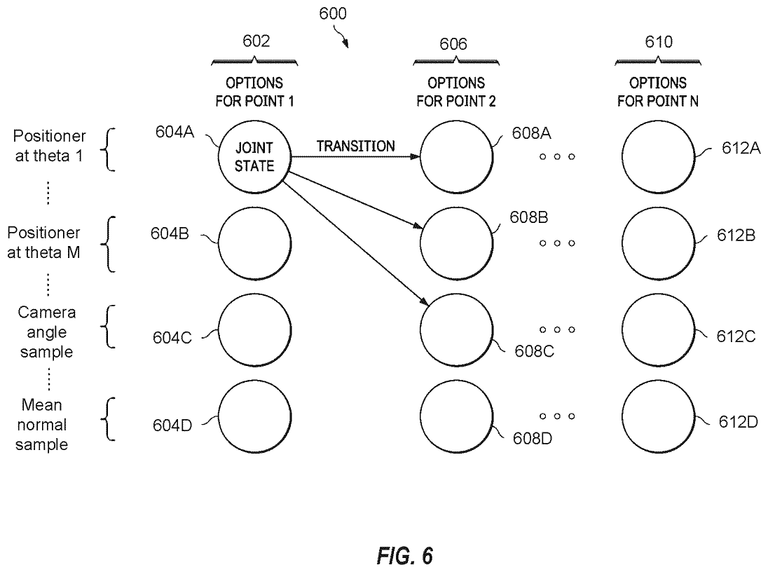

FIG. 6 is a schematic diagram of a technique for generating a plurality of candidate states according to one or more aspects. In some implementations, schematic diagram represents a graph-search technique by which the path plan for robot 120 may be determined (e.g., controller 152). For example, the graph-search technique may be performed using path planning logic 105.

In some implementations, each circle in the diagram 600 represents a different state of robot 120, such as a configuration of joints (of robot 120) that satisfies welding requirements, as illustrative, non-limiting examples. The joints may include or correspond to joints 302, 304, 402-406, or combinations thereof. Each arrow is a path that the robot can take to travel along a seam, such as along seam 144. To illustrate, each circle may be a specific location of robot 120 (e.g., the location of a weld head of robot 120 in 3D space) within workspace 130 and a different configuration of an arm of robot 120, as well as a position or configuration of a fixture supporting the part, such as a positioner, clamp, etc. Each column 602, 606, and 610 represents a different point, such as a waypoint, along a seam to be welded. Thus, for the seam point corresponding to column 602, robot 120 may be in any one of states 604A-604D. Similarly, for the seam point corresponding to column 606, robot 120 may be in any one of states 608A-608D. Likewise, for the seam point corresponding to column 610, robot 120 may be in any one of states 612A-612D. If, for example, robot 120 is in state 604A when at the seam point corresponding to column 602, robot 120 may then transition to any of the states 608A-608D for the next seam point corresponding to the column 606. Similarly, upon entering a state 608A-608D, robot 120 may subsequently transition to any of the states 612A-612D for the next seam point corresponding to the column 610, and so on. In some examples, entering a particular state may preclude entering other states. For example, entering state 604A may permit the possibility of subsequently entering states 608A-608C, but not 608D, whereas entering state 604B may permit the possibility of subsequently entering states 608C and 608D, but not states 608A-608B. The scope of this disclosure is not limited to any particular number of seam points or any particular number of robot states.

In some examples, to determine a path plan for robot 120 using the graph-search technique (e.g., according to the technique depicted in diagram 600), controller 152, such as path planning logic 105, may determine the shortest path from a state 604A-604D to a state corresponding to a seam point N (e.g., a state 612A-612D). By assigning a cost to each state and each transition between states, an objective function can be designed by a user or controller 152. The controller 152 finds the path that results in the least possible cost value for the objective function. Due to the freedom of having multiple starts and endpoints from which to choose, graph search methods like Dijkstra's algorithm or A* may be implemented. In some examples, a brute force method may be useful to determine a suitable path plan. The brute force technique would entail control system 110 (e.g., controller 152 or processor 101) computing all possible paths (e.g., through the diagram 600) and choosing the shortest one (e.g., by minimizing or maximizing the objective function). Simply put, the brute force method would compute all the possible paths through this graph and choose the shortest one. The complexity of the brute force method may be O(E), where E is the number of edges in the graph. Assuming N points in a scam with M options per point. Between any two layers, there are M*M edges. Hence, considering all layers, there are N*M*M edges. The time complexity is O(NM\hat{ }2), or O(E).

Controller 152, such as path planning logic 105, may determine whether the state at each seam point is feasible, meaning at least in part that controller 152 may determine whether implementing the chain of states along the sequence of seam points of the seam will cause any collisions between robot 120 and structures in workspace 130, or even with parts of robot 120 itself. To this end, the concept of realizing different states at different points of a scam may alternatively be expressed in the context of a seam that has multiple waypoints, such as waypoints 176.

In some implementations, controller 152 may discretize an identified seam, such as seam 144, into a sequence of waypoints. A waypoint may constrain an orientation of a manufacturing tool, such as manufacturing tool 126, connected to the robot 120 in three (spatial/translational) degrees of freedom. Manufacturing tool 126 may include or correspond to a weld head, and EE, or any combination thereof. Typically, constraints in orientation of manufacturing tool 126 of robot 120 are provided in one or two rotational degrees of freedom about each waypoint, for the purpose of producing some desired weld or other manufacturing operation of some quality; the constraints are typically relative to the surface normal vectors emanating from the waypoints and the path of the weld seam. For example, the position of manufacturing tool 126 can be constrained in x-, y-, and z-axes, as well as about one or two rotational axes perpendicular to an axis of the weld wire or tip of the welder, all relative to the waypoint and some nominal coordinate system attached to it. These constraints, in some examples, may be bounds or acceptable ranges for the angles. Those skilled in the art will recognize that the ideal or desired weld angle may vary based on part or seam geometry, the direction of gravity relative to the seam, and other factors. In some examples, controller 152 may constrain in a first position or a second position to ensure that the seam is perpendicular to gravity for one or more reasons (such as to find a balance between welding and path planning for optimization purposes). The position of manufacturing tool 126 can therefore be held (constrained) by each waypoint at any suitable orientation relative to the seam. Typically, the weld head will be unconstrained about a rotational axis (θ) coaxial with an axis of manufacturing tool 126. For instance, each waypoint can define a position of the manufacturing tool of robot 120 such that at each waypoint, the manufacturing tool is in a fixed position and orientation relative to the seam. In some implementations, the waypoints are discretized finely enough to make the movement of the manufacturing tool substantially continuous.

In some implementations, controller 152 may divide each waypoint into multiple nodes. Each node may represent a possible orientation of the weld head at that waypoint. As an illustrative, non-limiting example, the manufacturing tool can be unconstrained about a rotational axis coaxial with the axis of the manufacturing tool such that the manufacturing tool can rotate (e.g., 360 degrees) along a rotational axis 0 at each waypoint. Each waypoint can be divided into 20 nodes, such that each node of each waypoint represents the manufacturing tool at 18 degree of rotation increments. For instance, a first waypoint-node pair can represent rotation of the manufacturing tool at 0 degrees, a second waypoint-node pair can represent rotation of the manufacturing tool at 18 degrees, a third waypoint-node pair can represent rotation of the manufacturing tool at 36 degrees, etc. Each waypoint can be divided into 2, 10, 20, 60, 120, 360, or any suitable number of nodes. The subdivision of nodes can represent the division of orientations in more than 1 degree of freedom. For example, the orientation of an EE about the waypoint can be defined by 3 angles. A path or trajectory can be defined by linking each waypoint-node pair. Thus, the distance between waypoints and the offset between adjacent waypoint nodes can represent an amount of translation and rotation of the manufacturing tool as the manufacturing tool moves between node-waypoint pairs.

Controller 152, such as path planning logic 105, can evaluate each waypoint-node pair for a feasibility of performing an operation at the waypoint-node pair. For instance, if a waypoint is divided into 20 nodes, controller 152 can evaluate whether the first waypoint-node pair representing the manufacturing tool held at 0 degrees would be feasible. Stated differently, controller 152 can evaluate whether robot 120 would collide or interfere with a part (135, 136), fixture 127, or the robot itself, if placed at the position and orientation defined by that waypoint-node pair. In a similar manner, controller 152 can evaluate whether the second waypoint-node pair, third waypoint-node pair, etc., would be feasible. Controller 152 can evaluate each waypoint similarly. In this way, all feasible nodes of all waypoints can be determined.

In some examples, a collision analysis as described herein may be performed by comparing a 3D model of workspace 130 and a 3D model of robot 120 to determine whether the two models overlap, and optionally, some or all of the triangles overlap. The 3D model of workspace, the 3D model of robot 120, or both, may be stored at memory 102, or storage device 108, as illustrative, non-limiting examples. If the two models overlap, controller 152 may determine that a collision is likely. If the two models do not overlap, controller 152 may determine that a collision is unlikely. More specifically, in some examples, controller 152 may compare the models for each of a set of waypoint-node pairs (such as the waypoint node pairs described above) and determine that the two models overlap for a subset, or even possibly all, of the waypoint-node pairs. For the subset of waypoint-node pairs with respect to which model intersection is identified, controller 152 may omit the waypoint-node pairs in that subset from the planned path and may identify alternatives to those waypoint-node pairs. Controller 152 may repeat this process as needed until a collision-free path has been planned. Controller 152 may use a flexible collision library (FCL), which includes various techniques for efficient collision detection and proximity computations, as a tool in the collision avoidance analysis. The FCL may be stored at memory 102 or storage device 108, as illustrative, non-limiting examples. The FCL is useful to perform multiple proximity queries on different model representations, and it may be used to perform probabilistic collision identification between point clouds. Additional or alternative resources may be used in conjunction with or in lieu of the FCL.

Controller 152 can generate one or more feasible simulations (or evaluate, both terms used interchangeably herein) paths should they physically be feasible. A path can be a path that the robot (e.g., 120) takes to weld a seam or perform another operation, such as a scan operation. In some examples, the path may include all the waypoints of a seam. Alternatively, the path may include some but not all the waypoints of the seam. The path can include the motion of robot 120 and the manufacturing tool as the manufacturing tool moves between each waypoint-node pair. Once a feasible path between node waypoint pairs is identified, a feasible node-waypoint pair for the next sequential waypoint can be identified should it exist. Those skilled in the art will recognize that many search trees or other strategies may be employed to evaluate the space of feasible node-waypoint pairs. Additionally, or alternatively, as discussed herein, a cost parameter can be assigned or calculated for movement from each node-waypoint pair to a subsequent node-waypoint pair. The cost parameter can be associated with a time to move, an amount of movement (e.g., including rotation) between node-waypoint pairs, and/or a simulated/expected weld quality produced by the weld head during the movement.

In instances in which no nodes are feasible for welding for one or more waypoints and/or no feasible path exists to move between a previous waypoint-node pair and any of the waypoint-node pairs of a particular waypoint, controller 152, such as path planning logic 105, can determine alternative path planning parameters (e.g., path planning parameters 194) such that at least some additional waypoint-node pairs become feasible for welding or performing an operation such as a scan operation. For example, if controller 152 determines that none of the waypoint-node pairs for a first waypoint are feasible, thereby making the first waypoint unweldable or otherwise inoperable, controller 152 can determine alternative path planning parameters, such as an alternative weld angle so that at least some waypoint-node pairs for the first waypoint become weldable or operable. For example, controller 152 can remove or relax the constraints on rotation about the x and/or y axis. Similarly stated, controller 152 can allow the weld angle to vary in one or two additional rotational (angular) dimensions. For example, controller 152 can divide a waypoint that is unweldable into two- or three-dimensional nodes. Each node can then be evaluated for welding feasibility of the robot and weld in various weld angles and rotational states. The additional rotation about the x- and/or y-axes or other degrees of freedom may make the waypoints accessible to the manufacturing tool, such as the weld head, such that the manufacturing tool does not encounter any collision. In some implementations, controller 152—in instances in which no nodes are feasible for welding for one or more waypoints and/or no feasible path exists to move between a previous waypoint-node pair and any of the waypoint-node pairs of a particular waypoint—can use the degrees of freedom in determining feasible paths between a previous waypoint-node pair and any of the waypoint-node pairs of a particular waypoint.

Based on the generated paths, controller 152 can optimize the path for welding or perform other operation such as a scan operation. As used herein, optimal and optimize do not refer to determining an absolute best weld path, but generally refers to techniques by which weld time can be decreased and/or weld quality improved relative to less efficient weld paths. To illustrate, controller 152 can determine a cost function that seeks local and/or global minima for the motion of robot 120. Typically, the optimal weld path minimizes weld head rotation, as weld head rotation can increase the time to weld a seam and/or decrease weld quality. Accordingly, optimizing the weld path can include determining a weld path through a maximum number of waypoints with a minimum amount of rotation.

In evaluating the feasibility of welding at each of the divided nodes or node waypoint pairs, controller 152 may perform multiple computations. In some examples, each of the multiple computations may be mutually exclusive from one another. In some examples, the first computation may include kinematic feasibility computation, which computes whether the arm of robot 120 can mechanically reach (or exist) at the state defined by the node or node-waypoint pair. In some examples, in addition to the first computation, a second computation-which may be mutually exclusive to the first computation—may also be performed by controller 152. The second computation may include determining whether the arm of robot 120 will encounter a collision (e.g., collide with workspace 130 or a structure in workspace 130) when accessing the portion of the seam (e.g., the node or node-waypoint pair in question).

Controller 152, such as path planning logic 105, may perform the first computation before performing the second computation. In some examples, the second computation may be performed only if the result of the first computation is positive (e.g., if it is determined that the arm of robot 120 can mechanically reach (or exist) at the state defined by the node or node-waypoint pair). In some examples, the second computation may not be performed if the result of the first computation is negative (e.g., if it is determined that the arm of robot 120 cannot mechanically reach (or exist) at the state defined by the node or node-waypoint pair).

The kinematic feasibility may correlate with the type of robotic arm employed. In some implementations, robot 120 includes a six-axis robotic welding arm with a spherical wrist. The six-axis robotic arm can have 6 degrees of freedom-three degrees of freedom in X-, Y-, Z-cartesian coordinates and three additional degrees of freedom because of the wrist-like nature of robot 120. For example, the wrist-like nature of robot 120 results in a fourth degree of freedom in wrist-up/-down manner (e.g., wrist moving in +y and −y direction), a fifth degree of freedom in wrist-side manner (e.g., wrist moving in −x and +x direction), and sixth degree of freedom in rotation. In some examples, the welding torch or EE is attached to the wrist portion of robot 120.

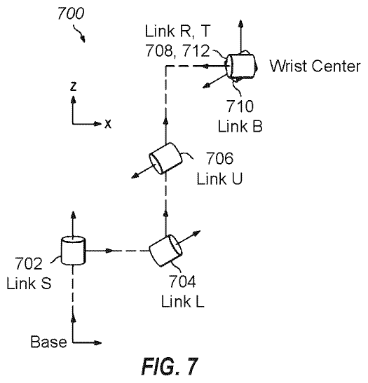

To determine whether the arm of robot 120 being employed can mechanically reach (or exist) at the state defined by the node or node-waypoint pair—e.g., to perform the first computation-robot 120 may be mathematically modeled. An example of a representation 700 of a robotic arm according to one or more aspects is shown with reference to FIG. 7. In some examples, controller 152, such as path planning logic 105, may solve for the first three joint variables based on a wrist position and solve for the other three joint variables based on wrist orientation. It is noted that an EE, such a torch (e.g., a weld head), is attached rigidly on the wrist. Accordingly, the transformation between torch tip and wrist is assumed to be fixed. Referring to FIG. 7, representation 700 of the robotic arm includes a base, a wrist center, and links B 710, L 704, R 708, S 702, T 712, and U 706, which may be considered as joint variables. To find the first three joint variables (e.g., variables S, L, U at 702, 704, 706, respectively), the geometric approach (e.g., law of cosines) may be employed.

After the first three joint variables (i.e., S, L, U) are computed successfully, controller 152 may then solve for the last three joint variables (i.e., R, B, T at 708, 710, 712, respectively) by, for example, considering wrist orientation as a Z-Y-Z Euler angle. Controller 152 may consider some offsets in robot 120. These offsets may need to be considered and accounted for because of inconsistencies in the unified robot description format (URDF) file. For example, in some examples, values (e.g., a joint's X axis) of the position of a joint (e.g., actual joint of robot 120) may not be consistent with the value noted in its URDF file. Such offset values may be provided to controller 152 in a table, such as a data stored at memory 102 or storage device 108. Controller 152, in some examples, may consider these offset values while mathematically modeling robot 120. In some examples, after robot 120 is mathematically modeled, controller 152 may determine whether the arm of robot 120 can mechanically reach (or exist) at the states defined by the node or node-waypoint pair.

As noted above, controller 152 can evaluate whether robot 120 would collide or interfere with one or more parts (135, 136), fixture 127, or anything else in workspace 130, including robot 120 itself, if placed at the position and orientation defined by that waypoint-node pair. Once controller 152 determines the states in which the robotic arm can exist, controller 152 may perform the foregoing evaluation (e.g., regarding whether the robot would collide something in its environment) using the second computation.

FIGS. 8A and 8B are diagrams of data structures that illustrate results of techniques of path clearance planning according to one or more aspects. For example, FIG. 8A shows a first data structure 800A and FIG. 8B shows a second data structure 800B. Each of first data structure 800A and second data structure 800B may have been generated by clearance logic 190. To illustrate, clearance logic 190 may use a first technique to generate first data structure 800A and may use a second technique to generate second data structure 800B.

Each of first data structure 800A and second data structure 800B includes a set of features of a robot (e.g., 120), an approach trajectory planning duration (approach_planning), a minimum approach clearance distance (appraoch_clearance), a retract trajectory planning duration (retract_planning), and a minimum retract clearance distance (retract_clearance). For each of the approach trajectory planning duration (approach_planning), the minimum approach clearance distance (appraoch_clearance), the retract trajectory planning duration (retract_planning), and the minimum retract clearance distance (retract_clearance), each of first data structure 800A and second data structure 800B includes a minimum value (min), a median value (median), an average value (average), and a maximum value (max).

To generate first data structure 800A, clearance logic 190 used ARA* along with a distance heuristics only. Additionally, a shortcut was also performed as part of post processing. First data structure 800A indicates that clearance logic 190 was unable to identify a path with sufficient clearance (less than or equal to 0.3 m) within the time limit (less than or equal to 100 sec).

To generate first data structure 800A, clearance logic 190 used a two-step approach. It is noted that finding a goal state took approximately 4-5 seconds and is included in the approach trajectory planning duration (approach_planning) and the retract trajectory planning duration (retract_planning) values. Additionally, no smoothing or shortcut was used to generate the second data structure 800B.

In some implementations, inverse kinematics (IK) solvers for robot manipulator control may include a gradient-based method which is known for having high performance in computational efficiency. However, the gradient-based method may be vulnerable to singularities. To address this problem (e.g., being vulnerable to singularities), for redundant manipulators, the null space of the Jacobian can be used to achieve a secondary objective in a configuration space to mitigate the numerical issues brought by singularities. However, the same method cannot be used for non-redundant manipulators since the null space does not exist. In this case where the null space does not exist, while the singularity robust (SR) inversion can still be applied on the nonredundant manipulators to minimize an evaluation index with both pose and configuration objectives terms, the pose error can become arbitrarily large since the trade-off between these two terms is not controllable.

To address this issue with the pose error, an SR IK solver may be configured to enable controlled deviation from an ideal IK solution by explicitly considering a weighted sum of the pose and configuration objectives, with the weights being adaptively determined on each degree of freedom (DoF) based on the singular values of the Jacobian. For a particular choice of weights, the result of the proposed approach for redundant manipulators is similar to the original SR inverse with desired joint configuration as the secondary objective.

For the SR IK solver, the gradient Δq used for IK solution searching can be decomposed into the following two terms:

$$Δ q = Δ qpose + Δ qstate , \qquad ( 1 )$$

where Δqpose=Vdiag {1−ωᵢ}Σ⁻¹ U^{T} δp is used for minimizing the task space pose error δp, and Δqstate=Vdiag {ωᵢ}V^{T} δq₀ is dedicated in minimizing the configuration space distance δq₀ between the current and the desire joint configuration. Σ, U, and V are the singular and unitary matrices generated by applying Singular Value Decomposition (SVD) on the Jacobian. ωᵢ, i=1, . . . , v are the blending weights corresponding to i-th out of v DoFs of the robot manipulator kinematics, and are adaptively determined by:

$${ω}_{i} = s / ( s + {σ}_{i}^{2} ) . \qquad ( 2 )$$

Here, σᵢ, i=1, . . . , v are the singular values from Σ, and s is an user-defined relaxation factor which serves both as a soft singularity boundary and a weight blending the objectives of Δqₛₜₐₜₑ and Δqₚₒₛₑ.

It is noted that the gradient Δq described by equations (1) and (2) has the following properties:
1) At singularity, the singular subspace is automatically used to serve Δqₛₜₐₜₑ's objective, while the nonsingular subspace is still dedicated in minimizing δp. When far away from singularity, the behavior of Δq becomes almost identical to the standard IK solver, which allows the proposed method to be applied universally without any separated handling logic for near to and far-from singularity cases.
2) Δq is smooth with respect to all σᵢ≥0, meaning that no non-smooth perturbation is introduced to the Jacobian along the whole IK solution searching process.

In some implementations, the post processing logic 192—e.g., a the trajectory correction step of an autonomous robotic welding pipeline—may be configured such that IK is solved per waypoint with the SR inversion formulation. In simulations that performed the post processing logic 192 (as described above) with reference to a trailer chassis with 324 trajectories passing through singularities, with s=1×10⁻⁴, all corrections succeeded with maximum and average position error magnitudes 5.82×10⁻³ m and 7.02×10⁻⁵ m, respectively. The results of a specific trajectory corrected with three different s are shown in Table I (below), it can be seen that as s decreases, the position error becomes smaller while the trajectory duration after time parameterization becomes larger. This example demonstrates how s can be used to control the trade-off between the pose and configuration objectives to achieve the desired SR inversion behavior.

TABLE I
Results of correction with SR inversion

| Relax. | Max. Pos. | Max. Rot. | Duration |
|---|---|---|---|
| factor | Error (m) | Error (rad) | (sec) |
| 1 × 10⁻³ | 2.30 × 10⁻³ | 4.75 × 10⁻³ | 8.03 |
| 1 × 10⁻⁴ | 1.90 × 10⁻³ | 4.01 × 10⁻³ | 9.35 |
| 1 × 10⁻⁵ | 1.53 × 10⁻³ | 3.51 × 10⁻³ | 11.45 |

Referring to FIG. 9, FIG. 9 is a graph 900 that illustrates an example of a pose-dependent minimum clearance bound according to one or more aspects. It is noted that the farther away from the seam, the larger the part location uncertainty. Accordingly, clearance logic 190 may use a monotonically increasing function of distance from start state. The function may include a generalized logistic function with two parameters. For example, the two parameters may include a location and a slope location and slope of the steepest point. In some implementations, a “cliff” could be set from or based on a pre-scan area size.

Referring to Table II (below), Table II depicts the results of the two algorithms for a trailer chassis with 118 seams to attach cross and diagonal beams to the frame. The desired clearance was 0.2 m. Clearance planning was attempted for approach and retract of the 109 seams for which weld planning was successful. The ARA*-based planner was successful in all attempts, although about ¼ of them resulted in insufficient clearances. The two-step planner failed to find an approach trajectory of one seam. Retract planning was attempted for the remaining seams and had one failure. However, all successful attempts yielded sufficient clearances. It also did not cause interseam (IS) planning failures, possibly because it used goal states that were closer to the robot base and therefore easier to find a collision-free path to the previous or next seam. Since the ARA*-based method chooses locally optimal state at each iteration, it may end up with a goal state on the far side of the workpiece from the robot base.

TABLE II
Results of the two clearance planning methods

| Method | Success/attempt | Time (s) | clearance <0.2 m | IS failure |
|---|---|---|---|---|
| ARA* | 218/218 | 109 | 55 | 3 |
| Two-step | 215/217 | 17.4 | 0 | 0 |

In some implementations, clearance logic 190 may perform the ARA* algorithm using a search-based motion planning library (SMPL) or the like. The ARA* algorithm may be faster than a two-step planner when there is sufficient open space around the part (e.g., 135 or 136). In some implementations, the ARA* algorithm can find an intermediate solution with insufficient clearance that may still be usable. Additionally, or alternatively the ARA* algorithm may return the same path for the same seam/setting.

In some implementations, clearance logic 190 may use a two-step planner to plan a trajectory. In some such implementations, the two-step planner may handle complex part geometry better (e.g., faster, or at a higher success rate) than an ARA* algorithm. However, the two-step planner may simply fail if either one of the steps fails. Additionally, or alternatively, the two-step planner's solution may vary for the same seam/setting from run to run.

Additionally, or alternatively, in some implementations, clearance logic 190 may use or implement multiple techniques to determine a path (e.g., 195). For example, clearance logic 190 may be configured to concurrently or sequentially perform multiple techniques. To illustrate, clearance logic 190 may use a time limited technique that provides at least a partial path (e.g., toward a goal state) at the end of time limited period. Clearance logic 190 may then implement another technique that is not time limited to determine an additional path from the end of the partial path to a goal state. A final path may include a combination of the partial path and the additional path.

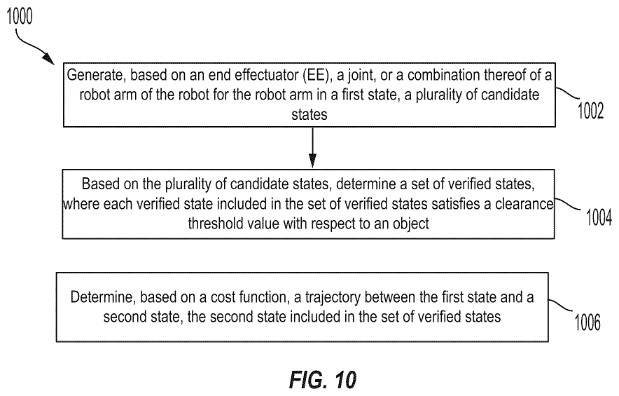

FIG. 10 is a flow diagram illustrating an example process 1000 of path clearance planning according to one or more aspects. Operations of process 1000 may be performed by a controller, such as controller 152 described above with reference to FIGS. 1-6. Example operations (also referred to as “blocks”) of process 1000 may enable controller 152 to support path clearance planning.

At block 1002, a controller associated with a robot is configured to generate, based on an EE, a joint, or a combination thereof of a robot arm of a robot for the robot arm in a first state, a plurality of candidate states. For example, controller 152 of control system 110 that is associated with robot 120 is configured to generate a plurality of candidate states, corresponding to candidate state data 169, based on an EE, a joint, or a combination thereof of a robot arm of robot 120 for the robot arm in a first state. The plurality of candidate states may include or correspond to candidate states 308, 418-432 as depicted in FIGS. 3C and 4C. The robot arm in the first state may include or correspond to the arm of robot as depicted in FIGS. 3A and 4A. Alternatively, the robot arm in the first state may include or correspond to the arm of the robot as depicted in FIGS. 3D and 4D.

At block 1004, the controller is configured to determine, based on the plurality of candidate states, a set of a set of verified states, where each verified state included in the set of verified states satisfies a clearance threshold value with respect to an object. For example, controller 152 may determine, based on plurality of candidate states 308, 418-432, a set of verified states. Each verified state 308, 420 included in the set of verified states satisfies clearance threshold value 318, 432 with respect to object 138.

At block 1006, the controller is configured to determine, based on a cost function, a trajectory between the first state and a second state, the second state included in the set of verified states. For example, controller 152 is configured to determine, based on a cost function, a trajectory between the first state, such as depicted in FIGS. 3A, 4A and a second state, such as depicted in FIGS. 3D, 4D. The second state, such as depicted in FIGS. 3D, 4D may be included in the set of verified states.

In some implementations, the first state includes an initial state or a goal state. For example, the first state may include an initial state depicted in FIGS. 3A, 4A or an initial state depicted in FIGS. 3D, 4D. Alternatively, the first state may include a goal state as depicted in the other of FIGS. 3A, 4A or FIGS. 3D, 4D.

In some implementations, the initial state is associated with an approach of the robot arm to perform an operation, or the goal state is associated with a retraction of the robot arm after performance of an operation. For example, the initial state may be associated with approach to scan 510 for a scan operation, while the goal state may be associated with retract for scan 512. Additionally or alternatively, the initial state may be associated with approach to weld 514 for a welding operation, while the goal state may be associated with retract from weld 516.

In some implementations, the operation includes a welding operation, a scan operation, or a combination thereof. For example, as depicted in FIG. 5, the operation may include or correspond to the weld operation (e.g., for approach to weld 514, retract from weld 516) or to the scan operation (e.g., for approach to scan 510, retract from scan 512).

In some implementations, to generate the plurality of candidate states, the controller is configured to determine one or more line segments associated with the robot arm. For example, controller 152 may be configured to determine line segment 306 that connects joint 302 to joint 304. As another example, controller 152 may be configured to determine line segments 410-416 that connect EE 408 to joints 402-406, respectively.

In some implementations, to generate the plurality of candidate states, the controller is configured to determine, for each line segment of the one or more line segments, a candidate state on the line segment and included in the plurality of candidate states. For example, controller 152 is configured to determine, for line segment 306, candidate state 308 that is located on line segment 306. As another example, controller 152 is configured to determine, for line segment 414, candidate state 420. As a further example, controller 152 is configured to determine, for line segment 416, candidate states 418-430.

In some implementations, to generate the plurality of candidate states, the controller is configured to determine, for each line segment of the one or more line segments, a number of candidate states associated with the line segment based on a length of the line segment. For example, to generate the plurality of candidate states, controller 152 is configured to determine, for each line segment of the one or more line segments, such as line segment 416, a number of candidate states 418-432 associated with line segment 416 based on a length of line segment 416.

In some implementations, to generate the plurality of candidate states, the controller determines, for each line segment of the one or more line segments, a number of candidate states associated with the line segment and that are evenly spaced along the line segment. For example, controller 152 determines, for line segment 416, a number of candidate states 418-432 associated with line segment 416 that are evenly spaced along line segment 416.

In some implementations, to generate the plurality of candidate states, the controller is configured to determine a series of line segments along robot arm. For example, to generate the plurality of candidate states, controller 152 is configured to determine a series of line segments 306, 316 along robot arm of robot 120.

In some implementations, to generate the plurality of candidate states, the controller is configured to determine a set of line segments from a first point on the robot arm to each of one or more other points on the robot arm. For example, controller 152 is configured to determine line segments 410-416 from a first point associated with EE 408 on the robot arm of robot 120 to each of one or more other points 402-406 on the robot arm.

In some implementations, the first point includes the end effectuator (EE) of the robot arm, at least one point of the one or more other points includes a joint of the robot arm, or a combination thereof. For example, the first point includes EE 408 of the robot arm, at least one point of the one or more other points includes joint 402-406 of the robot arm, or a combination thereof.

In some implementations, the object includes a part to be welded, a fixture configured to hold the part, or a combination thereof. For example, object 138 incudes first part 135, second part 136 to be welded, fixture 127 to hold first part 135 or second part 136, or a combination thereof.

In some implementations, to determine the set of verified states, the controller is configured, for each candidate state of the plurality of candidate states, to determine a distance between the candidate state and the object. For example, controller 152 is configured, for each candidate state of the plurality of candidate states 418-430, to determine a distance between the candidate state and object 138. To illustrate, controller 152 is configured to determine distance 432 between candidate state 420 and object 138.

In some implementations, to determine the set of verified states, the controller is configured, for each candidate state of the plurality of candidate states, to perform a first comparison based on the distance and the clearance threshold value. For example, controller 152 is configured, for candidate state 420 of the plurality of candidate states 418-432, to perform a first comparison based on distance 432 and a clearance threshold value corresponding to or associated with threshold values 174.

In some implementations, for each candidate state of the plurality of candidate states, the candidate state is included in the set of verified states based on the distance between the candidate state and the object being greater than or equal to the clearance threshold value. For example, controller 152 may include candidate state 420 in the set of verified states based on distance 420 between candidate state 420 and object 138 being greater than or equal to a clearance threshold value, such as may correspond to threshold values 174.

In some implementations, to determine the set of verified states, the controller is configured, for each candidate state of the plurality of candidate states, to perform a second comparison based on the distance and another threshold. For example, to determine the set of verified states, controller 152 is configured, for each candidate state of the plurality of candidate states, such as candidate state 308, to perform a second comparison based on distance 318 (e.g., between candidate state 308 and object 138.) and another threshold, such as corresponding to threshold values 174.

In some implementations, the candidate state is excluded from the set of verified states based on the distance between the candidate state and the object being greater than or equal to the other threshold. For example, candidate state 308 may be excluded from the set of verified states based on distance 318 between candidate state 308 and object 138 being greater than or equal to the other threshold, such as corresponding to threshold values 174.

In some implementations, to determine the trajectory, the controller is configured to apply the cost function to the set of verified states during a time period. For example, controller 152 may be configured to determine a trajectory included in path data 195 by applying a cost function to the set of verified states during a time period.

In some implementations, the controller is configured to determine whether the time period is lapsed. For example, controller 152 is configured to determine whether the time period is lapsed.

In some implementations, the controller is configured to stop application of the cost function. For example, controller 152 is configured to stop application of the cost function.

In some implementations, to determine the trajectory, the controller is configured to identify a portion of a path from the first state to the second state. For example, controller 152 is configured to identify a portion of a path from the first state to the second state.

In some implementations, to determine the trajectory, the controller is configured to determine that no feasible path exists between the first state and the second state. For example, controller 152 may be configured to determine that no feasible path exists between the first state (e.g., FIGS. 3A and 4A) and the second state (E.g., FIGS. 3D and 4D).

In some implementations, to determine the trajectory, the controller is configured to identify a complete path from the first state to the second state. For example, controller 152 may be configured to identify a complete path from first state (e.g., FIGS. 3A, 4A) to the second state (e.g., FIGS. 3D, 4D).

Although aspects of the present application and their advantages have been described in detail, it should be understood that various changes, substitutions and alterations can be made herein without departing from the spirit and scope of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding implementations described herein may be utilized. Accordingly, the appended claims are intended to include within their scope such processes, machines, manufacture, compositions of matter, means, methods, or steps.

The above specification provides a complete description of the structure and use of illustrative configurations. Although certain configurations have been described above with a certain degree of particularity, or with reference to one or more individual configurations, those skilled in the art could make numerous alterations to the disclosed configurations without departing from the scope of this disclosure. As such, the various illustrative configurations of the methods and systems are not intended to be limited to the particular forms disclosed. Rather, they include all modifications and alternatives falling within the scope of the claims, and configurations other than the one shown may include some or all of the features of the depicted configurations. For example, elements may be omitted or combined as a unitary structure, connections may be substituted, or both. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one configuration or may relate to several configurations. Accordingly, no single implementation described herein should be construed as limiting and implementations of the disclosure may be suitably combined without departing from the teachings of the disclosure.

While various implementations have been described above, it should be understood that they have been presented by way of example only, and not limitation. Although various implementations have been described as having particular features and/or combinations of components, other implementations are possible having a combination of any features and/or components from any of the examples where appropriate as well as additional features and/or components.

Certain features that are described in this specification in the context of separate implementations also can be implemented in combination in a single implementation. Conversely, various features that are described in the context of a single implementation also can be implemented in multiple implementations separately or in any suitable subcombination. Where methods described above indicate certain events occurring in certain order, the ordering of certain events may be modified. Additionally, certain of the events may be performed concurrently in a parallel process when possible, as well as performed sequentially as described above.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

Those of skill in the art would understand that information, message, and signals may be represented using any of a variety of different technologies and techniques. For example, data, instructions, commands, information, and signals that may be referenced throughout the above description may be represented by voltages, currents, electromagnetic waves, magnetic fields or particles, optical fields or particles, or any combination thereof.

Components, the functional blocks, and the modules described herein with the figures include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. The various illustrative logics, logical blocks, modules, circuits and algorithm processes described in connection with the implementations disclosed herein may be implemented as electronic hardware, computer software, or combinations of both. In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Additionally, the operations of a method or algorithm may reside as one or any combination or set of codes and instructions on a machine readable medium and computer-readable medium, which may be incorporated into a computer program product.

Some implementations described herein relate to methods or processing events. It should be understood that such methods or processing events can be computer-implemented. That is, where a method or other events are described herein, it should be understood that they may be performed by a compute device having a processor and a memory. Methods described herein can be performed locally, for example, at a compute device physically co-located with a robot or local computer/controller associated with the robot and/or remotely, such as on a server and/or in the “cloud.”

Memory of a compute device is also referred to as a non-transitory computer-readable medium, which can include instructions or computer code for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules, Read-Only Memory (ROM), Random-Access Memory (RAM) and/or the like. One or more processors can be communicatively coupled to the memory and operable to execute the code stored on the non-transitory processor-readable medium. Examples of processors include general purpose processors (e.g., CPUs), Graphical Processing Units, Field Programmable Gate Arrays (FPGAs), Application Specific Integrated Circuits (ASICs), Digital Signal Processor (DSPs), Programmable Logic Devices (PLDs), and the like. Examples of computer code include, but are not limited to, micro-code or micro-instructions, machine instructions, such as produced by a compiler, code used to produce a web service, and files containing higher-level instructions that are executed by a computer using an interpreter. To illustrate, examples may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise.

The term “about” as used herein can allow for a degree of variability in a value or range, for example, within 10%, within 5%, or within 1% of a stated value or of a stated limit of a range, and includes the exact stated value or range. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementation, the term “substantially” may be substituted with “within [a percentage] of” what is specified, where the percentage includes. 1, 1, 5, or 10 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise. Unless stated otherwise, the word or as used herein is an inclusive or and is interchangeable with “and/or,” such that when “or” is used in a list of two or more items, means that any one of the listed items can be employed by itself, or any combination of two or more of the listed items can be employed. To illustrate, A, B, and/or C includes: A alone, B alone, C alone, a combination of A and B, a combination of A and C, a combination of B and C, or a combination of A, B, and C. Similarly, the phrase “A, B, C, or a combination thereof” or “A, B, C, or any combination thereof” includes: A alone, B alone, C alone, a combination of A and B, a combination of A and C, a combination of B and C, or a combination of A, B, and C.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”). As a result, an apparatus that “comprises,” “has,” “includes,” or “contains” one or more elements possesses those one or more elements, but is not limited to possessing only those one or more elements. Likewise, a method that “comprises,” “has,” “includes,” or “contains” one or more steps possesses those one or more steps, but is not limited to possessing only those one or more steps.

Any implementation of any of the systems, methods, and article of manufacture can consist of or consist essentially of—rather than comprise/have/include-any of the described steps, elements, or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where”.

Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

The claims are not intended to include, and should not be interpreted to include, means-plus- or step-plus-function limitations, unless such a limitation is explicitly recited in a given claim using the phrase(s) “means for” or “step for,” respectively.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure and following claims are not intended to be limited to the examples and designs described herein but is to be accorded the widest scope consistent with the principles and novel features disclosed herein.

1. A computer-implemented method of generating instructions for a robot, the computer-implemented method comprising:
generating, based on an end effectuator (EE), a joint, or a combination thereof of a robot arm of the robot for the robot arm in a first state, a plurality of candidate states;
based on the plurality of candidate states, determining a set of verified states, where each verified state included in the set of verified states satisfies a clearance threshold value with respect to an object; and
determining, based on a cost function, a trajectory between the first state and a second state, the second state included in the set of verified states.

2. The computer-implemented method of claim 1, wherein:
the first state includes an initial state or a goal state;
the initial state is associated with an approach of the robot arm to perform an operation, or the goal state is associated with a retraction of the robot arm after performance of an operation;
the object includes a part to be welded, a fixture configured to hold the part, or a combination thereof; or
the operation includes a welding operation, a scan operation, or a combination thereof.

3. The computer-implemented method of claim 1, wherein generating the plurality of candidate states includes:
determining one or more line segments associated with the robot arm; and
determining, for each line segment of the one or more line segments, a candidate state on the line segment and included in the plurality of candidate states.

4. The computer-implemented method of claim 1, wherein generating the plurality of candidate states includes:
determining one or more line segments associated with the robot arm; and
determining, for each line segment of the one or more line segments, a number of candidate states associated with the line segment based on a length of the line segment.

5. The computer-implemented method of claim 1, wherein generating the plurality of candidate states includes:
determining one or more line segments associated with the robot arm; and
determining, for each line segment of the one or more line segments, a number of candidate states associated with the line segment and that are evenly spaced along the line segment.

6. The computer-implemented method of claim 1, wherein generating the plurality of candidate states includes determining a series of line segments along robot arm.

7. The computer-implemented method of claim 1, wherein:
generating the plurality of candidate states includes determining a set of line segments from a first point on the robot arm to each of one or more other points on the robot arm; and
the first point includes the end effectuator (EE) of the robot arm, at least one point of the one or more other points includes a joint of the robot arm, or a combination thereof.

8. The computer-implemented method of claim 1, wherein:
determining the set of verified states includes, for each candidate state of the plurality of candidate states:
determining a distance between the candidate state and the object; and
performing a first comparison based on the distance and the clearance threshold value; and
for each candidate state of the plurality of candidate states, the candidate state is included in the set of verified states based on the distance between the candidate state and the object being greater than or equal to the clearance threshold value.

9. The computer-implemented method of claim 1, wherein:
determining the set of verified states includes, for each candidate state of the plurality of candidate states:
determining a distance between the candidate state and the object;
performing a first comparison based on the distance and the clearance threshold value; and
performing a second comparison based on the distance and another threshold; and
the candidate state is excluded from the set of verified states based on the distance between the candidate state and the object being greater than or equal to the other threshold.

10. The computer-implemented method of claim 1, wherein determining the trajectory includes applying the cost function to the set of verified states during a time period, and further comprising:
determining whether the time period is lapsed; and
stopping application of the cost function.

11. The computer-implemented method of claim 1, wherein determining the trajectory includes:
identifying a portion of a path from the first state to the second state,
determining that no feasible path exists between the first state and the second state, or
identifying a complete path from the first state to the second state.

12. An assembly robotic system configured to scan an object to be welded, the assembly robotic system comprising:
a controller that includes one or more processors and one or more memories coupled to the one or more processors, the controller configured to:
generate, based on an end effectuator (EE), a joint, or a combination thereof of a robot arm of the robot for the robot arm in a first state, a plurality of candidate states;
based on the plurality of candidate states, determine a set of verified states, where each verified state included in the set of verified states satisfies a clearance threshold value with respect to an object; and
determine, based on a cost function, a trajectory between the first state and a second state, the second state included in the set of verified states.

13. The assembly robotic system of claim 12, wherein the first state includes an initial state or a goal state.

14. The assembly robotic system of claim 13, wherein the initial state is associated with an approach of the robot arm to perform an operation, or the goal state is associated with a retraction of the robot arm after performance of an operation.

15. The assembly robotic system of claim 12, wherein generating the plurality of candidate states includes determining one or more line segments associated with the robot arm.

16. The assembly robotic system of claim 12, wherein generating the plurality of candidate states includes determining a series of line segments along robot arm.

17. The assembly robotic system of claim 12, wherein:
generating the plurality of candidate states includes determining a set of line segments from a first point on the robot arm to each of one or more other points on the robot arm; and
the first point includes the end effectuator (EE) of the robot arm, at least one point of the one or more other points includes a joint of the robot arm, or a combination thereof.

18. The assembly robotic system of claim 12, wherein:
determining the set of verified states includes, for each candidate state of the plurality of candidate states:
determining a distance between the candidate state and the object; and
performing a first comparison based on the distance and the clearance threshold value.

19. The assembly robotic system of claim 12, wherein determining the trajectory includes applying the cost function to the set of verified states during a time period, and further comprising:
determining whether the time period is lapsed; and
stopping application of the cost function.

20. A non-transitory computer-readable medium storing instructions that, when executed by one or more processors of a controller cause the controller to:
generate, based on an end effectuator (EE), a joint, or a combination thereof of a robot arm of the robot for the robot arm in a first state, a plurality of candidate states;
based on the plurality of candidate states, determine a set of verified states, where each verified state included in the set of verified states satisfies a clearance threshold value with respect to an object; and
determine, based on a cost function, a trajectory between the first state and a second state, the second state included in the set of verified states.
